(19) United States
(12) Patent Application Publication
(10) Pub. No.: US 2026/0185395 A1
(43) Pub. Date: Jul. 2, 2026

(54) REFRIGERATOR, REFRIGERATOR DOOR AUTOMATIC OPENING SYSTEM AND CONTROL METHOD THEREOF

(71) Applicant: SAMSUNG ELECTRONICS CO., LTD., Suwon-si (KR)

(72) Inventor: Wooyeol YOO, Suwon-si (KR)

(21) Appl. No.: 19/442,236

(22) Filed: Jan. 7, 2026

Related U.S. Application Data
(63) Continuation of application No. PCT/KR2025/022685, filed on Dec. 24, 2025.

(30) Foreign Application Priority Data
Dec. 30, 2024 (KR) 10-2024-0201333

(51) Int. Cl. E05F 15/73; F25D 23/02; F25D 29/00

(52) U.S. Cl. CPC E05F 15/73; F25D 23/028; F25D 29/00; E05Y 2900/31; F25D 2700/04

(57) ABSTRACT

A refrigerator may include: a main body; a plurality of doors rotatably coupled to the main body; at least one door opening device configured to independently open the plurality of doors; a sensor on one door from among the plurality of doors, the sensor configured to detect a user or a user input; and at least one processor configured to: generate a processing signal by processing an output signal obtained from the sensor; generate a trigger signal based on an intensity of the processing signal being greater than or equal to a preset threshold value; determine to open at least two doors, including the one door, from among the plurality of doors based on a generation pattern of the trigger signal for a reference time; and control, based on determining to open the at least two doors, the at least one door opening device to open the at least two doors.

### CROSS-REFERENCE TO RELATED APPLICATIONS

This application is a bypass continuation application of International Patent Application No. PCT/KR2025/022685, filed on Dec. 24, 2025, which claims priority to Korean Patent Application No. 10-2024-0201333, filed in the Korean Intellectual Property Office on Dec. 30, 2024, the disclosures of which are herein incorporated by reference in their entireties.

### BACKGROUND

### 1. Field

Some embodiments of the present disclosure relate to a refrigerator and a door automatic opening system for a plurality of refrigerators.

### 2. Description of Related Art

A refrigerator is equipment for keeping food fresh by including a main body having a storage room and a cool air supply system for supplying cool air to the storage room. The storage room may include a refrigerating room that is maintained at about 0° C. to 5° C. to keep food refrigerated, and a freezing room that is maintained at about 0° C. to 30° C. below zero to keep food frozen. A front side of the storage room may open to put food in or take food out.

The refrigerator may include a door which opens or closes the storage room. The door may be rotatable with respect to the main body to open or close the storage room.

The door may be opened or closed when a user holds a handle provided in the door and rotates the door with respect to the main body. Alternatively, the refrigerator may include a door opening and closing structure configured to enable the door to be easily opened or closed.

When s user holds food to be stored in the refrigerator in both hands, he or she may have difficulties in holding the handle. There is a need for technology that automatically opens the door without a user's operation of manually holding the handle and rotating the door in order to improve the user experience.

### SUMMARY

A refrigerator or a refrigerator door automatic opening system according to an embodiment of present disclosure may detect a user through a sensor and automatically open a desired door of the refrigerator without the user's direct intervention in opening the door.

According to some embodiments of the present disclosure, a refrigerator may include: a main body; a plurality of doors rotatably coupled to the main body; at least one door opening device configured to independently open the plurality of doors; a sensor on one door from among the plurality of doors, the sensor configured to detect a user or a user input; and at least one processor configured to: generate a processing signal by processing an output signal obtained from the sensor; generate a trigger signal based on an intensity of the processing signal being greater than or equal to a preset threshold value; determine to open at least two doors, including the one door, from among the plurality of doors based on a generation pattern of the trigger signal for a reference time; and control, based on determining to open the at least two doors, the at least one door opening device to open the at least two doors.

According to some embodiments of the present disclosure, a refrigerator door automatic opening system may include: a plurality of refrigerators including a first refrigerator and a second refrigerator. The first refrigerator including: a first door; a first door opening device configured to open the first door; a first communication interface; at least one first processor connected to the first door opening device and the first communication interface; and a sensor on the first door, the sensor configured to detect a user or a user input. The second refrigerator include: a second door; a second door opening device configured to open the second door; a second communication interface; and at least one second processor connected to the second door opening device and the second communication interface, wherein the at least one first processor of the first refrigerator is configured to: generate a processing signal by processing an output signal obtained from the sensor; generate a trigger signal based on an intensity of the processing signal being greater than or equal to a preset threshold value; determine, based on a generation pattern of the trigger signal for a reference time, to open the first door of the first refrigerator and the second door of the second refrigerator; control, based on determining to open the first door, the first door opening device to open the first door of the first refrigerator; and control, based on determining to open the second door, the first communication interface to transmit a door opening signal to the second refrigerator to open the second door.

According to an aspect of the present disclosure, it may be possible to open a desired door based on a sensor detecting a user without the user's operation of holding a handle.

According to an aspect of the present disclosure, it may be possible to open a desired door, even when a sensor installed on a specific door fails, based on a detection of a user by another sensor installed on another door.

According to an aspect of the present disclosure, it may be possible to open a plurality of doors without a user's intervention.

Also, according to an aspect of the present disclosure, it may be possible to improve a user's experience by allowing the user to preset a refrigerator or a door which he or she wants to open.

Aspects of embodiments of the present disclosure are not limited to the above-mentioned aspects, and other unmentioned aspects of the present disclosure will be clearly understood by one of ordinary skill in the technical art to which the present disclosure belongs from the following description.

### BRIEF DESCRIPTION OF DRAWINGS

FIG. 1 shows a plurality of apparatuses in an Internet of Things (IoT) environment according to an embodiment.

FIG. 2 is a perspective view showing an example of a refrigerator according to an embodiment when doors of the refrigerator are closed.

FIG. 3 is a perspective view showing a refrigerator according to an embodiment when doors of the refrigerator are open.

FIG. 4 is a top view of a refrigerator according to an embodiment when doors of the refrigerator are closed.

FIG. 5 is a top view of a refrigerator according to an embodiment when a door opening device opens doors of the refrigerator.

FIG. 6 is a perspective view showing another example of a refrigerator according to an embodiment when doors of the refrigerator are closed.

FIG. 7 is a top view of a refrigerator according to an embodiment when doors of the refrigerator are closed.

FIG. 8 is a top view of a refrigerator according to an embodiment when a door opening device opens a sub door of the refrigerator.

FIG. 9 is a control block diagram of a refrigerator according to an embodiment.

FIG. 10 is a diagram for describing an example of a method of processing an output signal obtained from a sensor included in a refrigerator according to an embodiment.

FIG. 11 is a diagram for describing another example of a method of processing an output signal obtained from a sensor included in a refrigerator according to an embodiment.

FIG. 12 is a control flowchart of a refrigerator according to an embodiment.

FIG. 13 is an example of a control flowchart for identifying a door to be automatically opened in a refrigerator, according to an embodiment.

FIG. 14 is an example of a control flowchart for identifying a door to be automatically opened in a refrigerator, according to an embodiment.

FIG. 15 shows an example of a refrigerator according to an embodiment.

FIG. 16 shows an example of a refrigerator according to an embodiment.

FIG. 17 is a block diagram schematically showing a plurality of refrigerators in an IoT environment according to an embodiment.

FIG. 18 is a control flowchart of a refrigerator door automatic opening system according to an embodiment.

FIG. 19 is an example of a flowchart for automatically opening doors of a plurality of refrigerators in a refrigerator door automatic opening system according to an embodiment.

FIG. 20 is an example of a flowchart for automatically opening doors of a plurality of refrigerators in a refrigerator door automatic opening system according to an embodiment.

FIG. 21 is an example of a flowchart for automatically opening doors of a plurality of refrigerators in a refrigerator door automatic opening system according to an embodiment.

FIG. 22 is an example of a flowchart for automatically opening doors of a plurality of refrigerators in a refrigerator door automatic opening system according to an embodiment.

### DETAILED DESCRIPTION

Various example embodiments of the present disclosure and terms used in the present disclosure are not intended to limit the present disclosure to specific embodiments, and embodiments of the present disclosure should be understood to include various modifications, equivalents, and substitutions of the corresponding example embodiments.

In describing of the drawings, similar reference numerals may be used for similar or related elements.

The singular form of a noun corresponding to an item may include one or more of the items unless clearly indicated otherwise in a related context.

In the present disclosure, phrases, such as “A or B,” “at least one of A and B,” “at least one of A or B,” “A, B or C,” “at least one of A, B and C,” and “at least one of A, B, or C” may include any one or all possible combinations of the items listed together in the corresponding phrase among the phrases.

As used herein, the term “and/or” includes any and all combinations of one or more of the associated listed items.

Terms such as “first,” “second,” “primary,” or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes,” “comprises,” “including,” and/or “comprising” are used in the present disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to,” “coupled to,” “supported by” or “in contact with” another element, it is to be understood that it may be directly or indirectly connected to, coupled to, supported by, or in contact with the other element. When a given element is indirectly “connected to,” “coupled to,” “supported by,” or “in contact” with another element, it is to be understood that it may be connected to, coupled to, supported by, or in contact with the other element through a third element.

It will also be understood that when an element is referred to as being “on” another element, it may be directly on the other element or intervening elements may also be present.

A refrigerator according to an embodiment of the present disclosure may include a main body.

The “main body” may include an inner case, an outer case positioned outside the inner case, and an insulation provided between the inner case and the outer case.

The “inner case” may include a case, a plate, a panel, or a liner forming a storage compartment (also referred to as a storage room). The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate an inside of the storage compartment from an outside of the storage compartment to maintain inside temperature of the storage compartment at appropriate temperature without being influenced by an external environment of the storage compartment. According to an embodiment of the present disclosure, the insulation may include a foaming insulation. The foaming insulation may be molded by fixing the inner case and the outer case with jigs, etc., and then injecting and foaming urethane foam as a mixture of polyurethane and a foaming agent between the inner case and the outer case.

According to an embodiment of the present disclosure, the insulation may include a vacuum insulation in addition to a foaming insulation, or may be configured only with a vacuum insulation instead of a forming insulation. The vacuum insulation may include a core material and a cladding material accommodating the core material and sealing the inside with vacuum or pressure close to vacuum. However, the insulation is not limited to the above-mentioned foaming insulation or vacuum insulation, and may include various materials capable of being used for insulation.

The “storage compartment” may include a space defined by the inner case. The storage compartment may further include the inner case defining the space corresponding to the storage compartment. The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulation.

The storage compartment may be maintained within an appropriate temperature range according to a purpose of use, and may include a “refrigerating compartment,” a “freezing compartment,” and a “temperature conversion compartment” according to purposes of use and/or temperature ranges. The refrigerating compartment may be maintained at an appropriate temperature to keep food refrigerating, and the freezing compartment may be maintained at an appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of −20 degrees Celsius to −1 degrees Celsius. The temperature conversion compartment may be used as either a refrigerating compartment or a freezing compartment according to or regardless of a user's selection.

The storage compartment may also be referred to by various terms, such as “vegetable compartment,” “freshness compartment,” “cooling compartment,” and “ice-making compartment,” in addition to “refrigerating compartment,” “freezing compartment,” and “temperature conversion compartment,” and the terms, such as “refrigerating compartment,” “freezing compartment,” “temperature conversion compartment,” etc., as used below are to be understood as representing storage compartments having the corresponding purposes of use and the corresponding temperature ranges.

The refrigerator according to an embodiment of the present disclosure may include at least one door configured to open or close the open side of the storage compartment. The respective doors may be provided to open and close one or more storage compartments, or a single door may be provided to open and close a plurality of storage compartments. The door may be rotatably or slidably mounted to the front of the main body.

The “door” may seal the storage compartment in a closed state. The door, like the main body, may include an insulation to insulate the storage compartment in a closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forming the front surface of the door. The door body may include an outer door plate forming the front surface of the door body, an inner door plate forming the rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

The refrigerator according to an embodiment of the present disclosure may include a cold air supply device for supplying cold air to the storage compartment.

The “cold air supply device” may include a machine, an apparatus, an electronic device, and/or a combination system thereof, capable of generating cold air and guiding the cold air to cool the storage compartment.

According to an embodiment of the present disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to an embodiment of the present disclosure, the cold air supply device may include a semiconductor, such as a thermoelectric element. The thermoelectric element may cool the storage compartment by heating and cooling actions through the Peltier effect.

The refrigerator according to an embodiment of the present disclosure may include a machine compartment in which at least some components belonging to the cold air supply device are installed.

The “machine compartment” may be partitioned and insulated from the storage compartment to prevent heat generated by the components installed in the machine compartment from being transferred to the storage compartment. To dissipate heat from the components installed in the machine compartment, the machine compartment may communicate with outside of the main body.

The refrigerator according to an embodiment of the present disclosure may include a dispenser provided on the door to provide water and/or ice. The dispenser may be provided on the door to allow access by the user without opening the door.

The refrigerator according to an embodiment of the present disclosure may include an ice-making device that produces ice. The ice-making device may include an ice-making tray that stores water, an ice-moving device that separates ice from the ice-making tray, and an ice-bucket that stores ice produced in the ice-making tray.

Hereinafter, various non-limiting example embodiments according to the present disclosure will be described in detail with reference to the accompanying drawings.

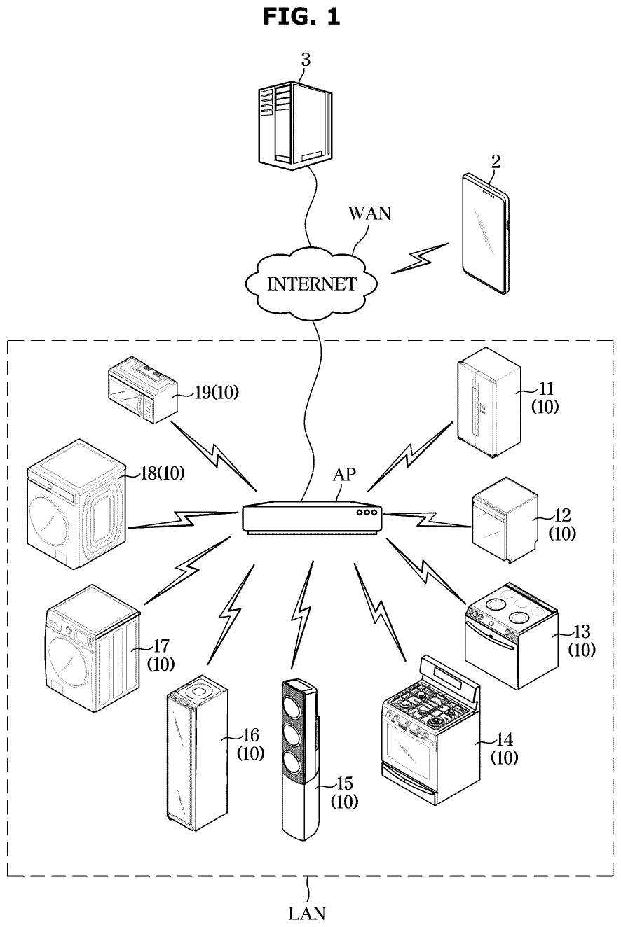

FIG. 1 shows a plurality of apparatuses in an Internet of Things (IoT) environment according to an embodiment.

The IoT environment according to an embodiment may include a user device 2, a server device 3, at least one electronic device 10, and/or a network that connects the user device 2, the server device 3, or the at least one electronic device 10 to each other. In the present disclosure, the user device 2 or the at least one electronic device 10 in the IoT environment may be referred to as an IoT device.

The electronic device 10 may include a communication module capable of communicating with another home appliance, a user device 2, or a server 3, a user interface that receives a user input or outputs information to a user, at least one processor that controls an operation of the electronic device 10, and at least one memory that stores a program for controlling the operation of the electronic device 10.

The electronic device 10 may be at least one of various types of home appliances. For example, as shown in the accompanying drawings, the electronic device 10 may include a refrigerator 11, a dishwasher 12, an electric range 13, an electric oven 14, an air conditioner 15, a clothes treating apparatus 16, a washing machine 17, a dryer 18, and a microwave oven 19, but is not limited thereto. For example, the electronic device 10 may include various types of appliances not shown in the drawings, such as a cleaning robot, a vacuum cleaner, a television, and the like. Furthermore, the aforementioned home appliances are by way of example only, and in addition to the aforementioned home appliances, other appliances connected to other home appliance, the user device 2, or the server 3 to perform operations described below may be included in the electronic device 10 according to an embodiment.

The server 3 may include a communication module communicating with another server, the electronic device 10, or the user device 2, at least one processor that processes data received from another server, the electronic device 10, or the user device 2, and at least one memory that stores programs for processing data or processed data. The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the electronic device 10 in association with the user account, managing or controlling the registered electronic device 10, and the like. For example, a user may access the server 3 via the user device 2 and may create a user account. The user account may be identified by an identifier (ID) and a password set by the user. The server 3 may register the electronic device 10 with the user account according to a predetermined procedure. For example, the server 3 may link identification information of the electronic device 10 (e.g., a serial number or a media access control (MAC) address) to the user account to register, manage, and control the electronic device 10. The user device 2 may include a communication module capable of communicating with the server 3, a user interface that receives a user input or outputs information to a user, at least one processor that controls an operation of the user device 2, and at least one memory that stores a program for controlling the operation of the user device 2.

The user device 2 may be carried by a user, or placed in a user's home or office, or the like. The user device 2 may include a personal computer (PC), a terminal, a portable telephone, a smartphone, a handheld device, a wearable device, and the like, but is not limited thereto.

The memory of the user device 2 may store a program (e.g., an application) for controlling the electronic device 10. The application may be sold installed on the user device 2, or may be downloaded from an external server for installation.

By running the application installed on the user device 2 by a user, the user may access the server 3, create a user account, and communicate with the server 3 based on the login user account to register the electronic device 10.

For example, by operating the electronic device 10 to allow the electronic device 10 to access the server 3 according to a procedure guided by the application installed on the user device 2, the server 3 may register the electronic device 10 with the user account by assigning the identification information (e.g., a serial number or a MAC address) of the electronic device 10 to the corresponding user account.

A user may control the electronic device 10 using the application installed on the user device 2. For example, by logging into a user account with the application installed on the user device 2, the electronic device 10 registered in the user account appears, and by inputting a control command for the electronic device 10, the control command may be delivered to the electronic device 10 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth™ (IEEE 802.15.1), Zigbee (IEEE 802.15.4), Wi-Fi Direct, near field communication (NFC), and Z-Wave, but is not limited thereto.

The AP may connect the electronic device 10 or the user device 2 to a WAN connected to the server 3. The electronic device 10 or the user device 2 may be connected to the server 3 via a WAN.

The AP may communicate with the electronic device 10 or the user device 2 using wireless communication, such as Wi-Fi™ (IEEE 802.11), Bluetooth™ (IEEE 802.15.1), Zigbee (IEEE 802.15.4), and the like, and access a WAN using wired communication, but is not limited thereto.

According to various embodiments, the electronic device 10 may be directly connected to the user device 2 or the server 3 without going through an AP.

The electronic device 10 may be connected to the user device 2 or the server 3 via a long-range wireless network or a short-range wireless network.

For example, the electronic device 10 may be connected to the user device 2 via a short-range wireless network (e.g., Wi-Fi Direct).

In another example, the electronic device 10 may be connected to the user device 2 or the server 3 via a WAN using a long-range wireless network (e.g., a cellular communication module).

In still another example, the electronic device 10 may access a WAN using wired communication, and may be connected to another electronic device 10 or the server 3 via a WAN.

When accessing a WAN using wired communication, the electronic device 10 may also act as an AP. Accordingly, the electronic device 10 may connect another electronic device 10 to a WAN to which the server 3 is connected. In addition, another electronic device 10 may connect the electronic device 10 to the WAN to which the server 3 is connected.

The electronic device 10 may transmit information about an operation or state to other home appliances, the user device 2, or the server 3 via the network. For example, the electronic device 10 may transmit information about an operation or state to other home appliances, the user device 2 or the server 3 upon receiving a request from the server 3, in response to an event in the electronic device 10, or periodically or in real time.

Upon receiving the information about the operation or state from the electronic device 10, the server 3 may update the stored information about the operation or state of the electronic device 10 and transmit the updated information about the operation and state of the electronic device 10 to the user device 2 via the network. Here, updating the information may include various operations in which existing information is changed, such as adding new information to the existing information, replacing the existing information with new information, and the like.

The electronic device 10 may obtain various information from other home appliances, the user device 2, or the server 3, and may provide the obtained information to a user. For example, the electronic device 10 may obtain information related to a function of the electronic device 10 (e.g., recipes, washing instructions, etc.) from the server 3 and various environmental information (e.g., weather, temperature, humidity, etc.), and may output the obtained information via a user interface.

The electronic device 10 may operate in accordance with a control command received from other home appliances, the user device 2, or the server 3. For example, the electronic device 10 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the electronic device 10 or the server 3 via the communication module. For example, the user device 2 may transmit information about a user's location, a user's health condition (i.e., state), a user's preference, a user's schedule, and the like to the server 3. The user device 2 may transmit information about the user to the server 3 based on the user's prior authorization.

The electronic device 10, the user device 2, or the server 3 may use techniques, such as artificial intelligence (AI) to determine a control command. For example, the server 3 may receive information about an operation or a state of the electronic device 10 or information about a user of the user device 2, process the received information using techniques, such as AI, and transmit a processing result or a control command to the electronic device 10 or the user device 2 based on the processing result.

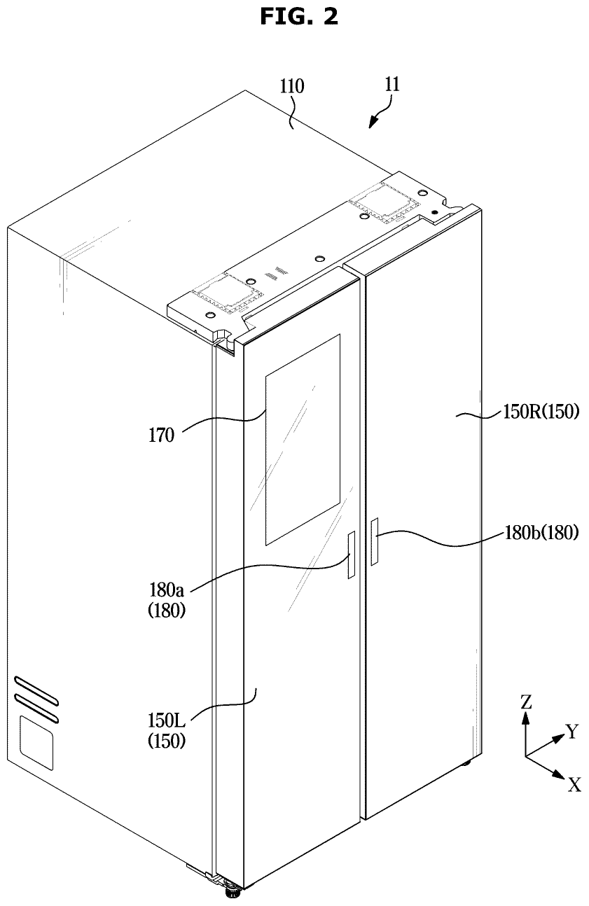

FIG. 2 is a perspective view showing a refrigerator according to an embodiment when doors of the refrigerator are closed.

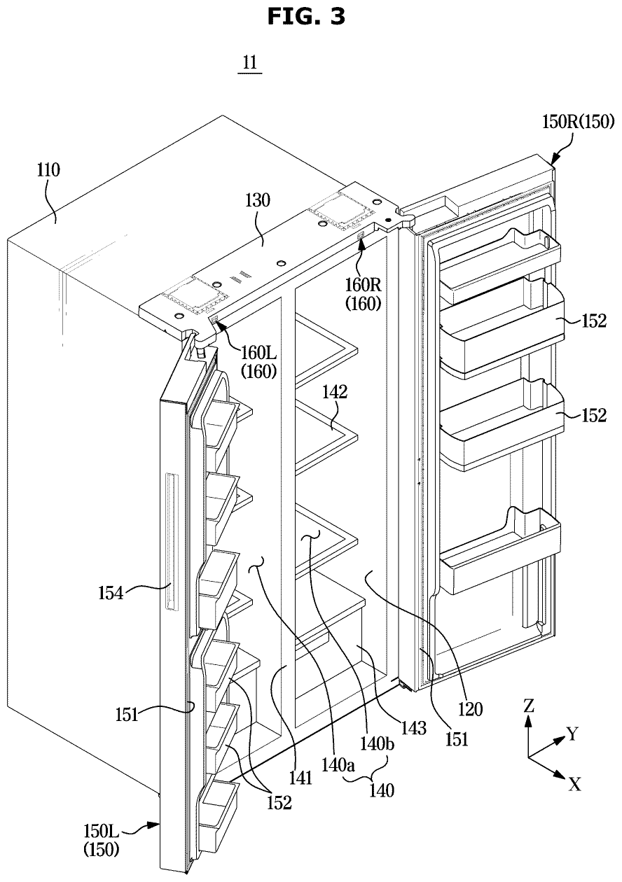

FIG. 3 is a perspective view showing a refrigerator according to an embodiment when doors of the refrigerator are open.

Referring to FIGS. 2 and 3, a refrigerator 11 according to an embodiment of the present disclosure may include a main body 100, a storage room 140 provided inside the main body 100, at least one door 150 for opening or closing the storage room 140, and a cooling system for supplying cool air to the storage room 140.

The main body 100 may include an outer case 110 forming an outer appearance of the refrigerator 11, and an inner case 120 forming the storage room 140. The outer case 110 may be substantially in a shape of a box of which a front side opens. The outer case 110 may form upper and lower surfaces, left and right surfaces, and a rear surface of the refrigerator 11. The inner case 120 may open at the front side. The inner case 120 may form the storage room 140 therein and be provided inside the outer case 110. The inner wall of the inner case 120 may form an inner wall of the storage room 140.

An insulation for insulating between the outer case 110 and the inner case 120 may be provided between the outer case 110 and the inner case 120. The insulation may be foamed between the outer case 110 and the inner case 120 to couple the inner case 120 to the outer case 120. For example, the insulation may include various insulation materials, such as a urethane foam insulation, an expanded polystyrene (EPS) insulation, and a vacuum insulation panel.

The main body 100 may further include a top table 130 mounted on a top of the main body 100. The top table 130 may be coupled to an upper portion of the outer case 110. The top table 130 may be coupled to a top of the outer case 110. The top table 130 may cover various electrical components. An accommodation space for accommodating various electrical components may be formed inside the top table 130. For example, the top table 130 may cover at least one door opening device 160 which will be described below, and the at least one door opening device 160 may be accommodated inside the top table 130.

The storage room 140 may be formed inside the main body 100. For example, the storage room 140 may include a refrigerating room that is maintained at about 0° C. to 5° C. to keep food refrigerated. For example, the storage room 140 may include a freezing room that is maintained at about 0° C. to 30° C. below zero to keep food frozen.

According to various embodiments, the storage room 140 may be partitioned into a plurality of areas. The main body 100 may include a partition wall 141 that partitions the storage room 140 into a first storage room 140a and a second storage room 140b. For example, the partition wall 141 may extend in a vertical direction Z, and the first storage room 140a and the second storage room 140b may be arranged with respect to each other in a horizontal direction Y. For example, the storage room 140 may be partitioned into the first storage room 140a positioned at the left side and the second storage room 140b positioned at the right side. For example, the first storage room 140a may be used as a freezing room, and the second storage room 140b may be used as a refrigerating room. However, embodiments of the present disclosure are not limited thereto.

Inside the storage room 140, at least one storage room shelf 142 on which food is put and at least one drawer 143 for keeping food may be provided.

The refrigerator 11 may include a cooling system for generating cool air by using a cooling cycle and supplying the generated cool air to the storage room 140. The cooling system may generate cool air by using a cooling circulation cycle of compressing, condensing, expanding, and evaporating refrigerants. For example, the cooling system may include a compressor, a condenser, an expansion valve, an evaporator, and a blow fan.

The main body 100 may include a cool air supply duct that forms a flow path of cool air through which cool air generated by the cooling system flows to the storage room 140. The cool air supply duct may be formed at a rear portion of the inner case 120. The cool air supply duct may be positioned at a rear portion of the storage room 140 and communicate with the storage room 140.

The door 150 may open or close the storage room 140. The door 150 may open or close an opening formed in one side of the main body 100. The door 150 may be rotatable with respect to the main body 100. The door 150 may be coupled to a hinge bracket connecting the door 150 to the main body 100 to be rotatable with respect to the main body 100.

An outer surface of the door 150 may form a part of the appearance of the refrigerator 11. While the door 150 is at a closed position, the outer surface of the door 150 may form at least a part of a front appearance of the refrigerator 11. While the door 150 is at the closed position, an inner surface of the door 150 may face an inside of the storage room 140. The inner surface of the door 150 may be one surface of the door 150 that faces the storage room 140 while the door 150 closes the storage room 140. Also, the outer surface of the door 150 may be another surface of the door 150 that is opposite to the inner surface of the door 150, facing the storage room 140, while the door 150 closes the storage room 140, and may be a front surface of the door 150 seen in a front direction of the refrigerator 11.

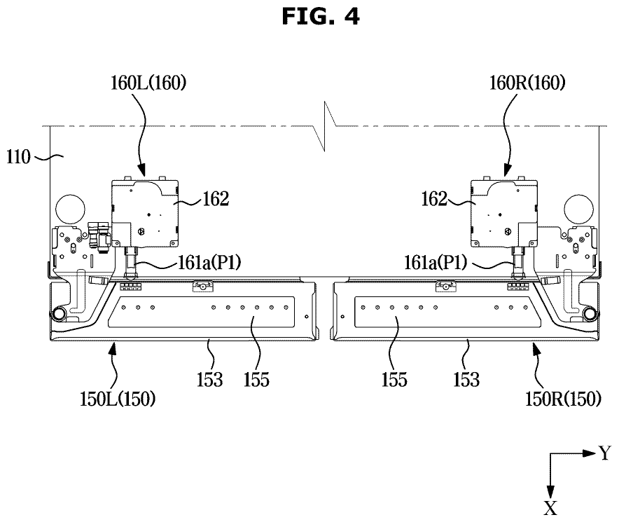

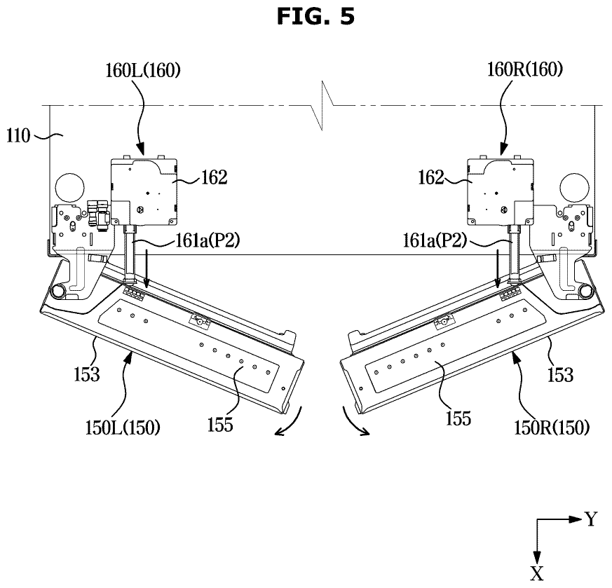

For example, the door 150 may include a door frame 153 and at least one door cap 155 (see FIGS. 4 and 5). The at least one door cap 155 may include an upper door cap and/or a lower door cap. The door frame 153 may form an overall appearance of the door 150. The at least one door cap 155 may form an upper side and/or a lower side of the door 150.

On the inner surface of the door 150, a door gasket 151 that seals up a gap between the door 150 and the main body 100 to prevent cool air of the storage room 140 from leaking out may be positioned. The door gasket 151 may be positioned along edges of the inner surface of the door 150. The door gasket 151 may include an elastic material such as rubber.

On the inner surface of the door 150, at least one door shelf 152 may be provided to accommodate food. The door 150 may include the door frame 153. The door frame 153 may form an overall appearance of the door 150.

The door 150 may include a handle 154. A user may hold the handle 154 with his/her hand and open or close the door 150. In other words, the user may hold the handle 154 with his/her hand and rotate the door 150 to open or close the storage room 140. For example, the handle 154 may include a concave groove that enables a user to hold the handle 154. For example, the handle 154 may be provided in the door frame 153 of the door 150.

The door 150 may be opened by the door opening device 160, which will be described below.

The refrigerator 11 may include at least one sensor 180 that obtains a signal for operating the at least one door opening device 160, which will be described below. For example, the sensor 180 may be provided on the door 150. For example, the sensor 180 may be positioned adjacent to the handle 154 of the door 150.

The refrigerator 11 may include a plurality of doors 150 that respectively open or close a plurality of storage rooms partitioned from each other. For example, the refrigerator 11 may include a first door 150L that opens or closes the first storage room 140a, and a second door 150R that opens or closes the second storage room 140b. For example, the first door 150L and the second door 150R may be arranged side by side with respect to each other in the horizontal direction Y. The first door 150L may be positioned at the left side and the second door 150R may be positioned at the right side. The first door 150L may be referred to as a “left door” and the second door 150R may be referred to as a “right door.” The first door 150L and the second door 150R may rotate independently with respect to the main body 100.

For example, the first door 150L may be opened by a first door opening device 160L positioned at the left side. For example, the second door 150R may be opened by a second door opening device 160R positioned at the right side.

For example, the first door 150L may include a first sensor 180a that obtains a signal for operating the first door opening device 160L. For example, the second door 150R may include a second sensor 180b that obtains a signal for operating the second door opening device 160R.

The doors 150 of the refrigerator 11 according to various embodiments of the present disclosure are not limited to the first door 150L and the second door 150R described above.

The refrigerator 11 may include a control panel 170. The control panel 170 may be provided on the main body 100 or the door 150. For example, the control panel 170 may be provided on the outer surface of the first door 150L, which is shown in FIG. 2.

The control panel 170 may provide a user with a user interface for interactions with the user.

Components of the refrigerator 11 described above with reference to FIGS. 2 and 3 are non-limiting example components for describing a refrigerator according to an embodiment of the present disclosure, and the embodiments of the present disclosure are not limited thereto. According to various embodiments of the present disclosure, the refrigerator 11 may include various components that perform a function of supplying cool air to the storage room 140 for storing food.

FIG. 4 is a top view of a refrigerator according to an embodiment when doors of the refrigerator are closed.

FIG. 5 is a top view of a refrigerator according to an embodiment when a door opening device opens doors of the refrigerator.

The refrigerator 11 according to an embodiment of the present disclosure may include the at least one door opening device 160 for opening the at least one door 150. The door opening device 160 may rotate the door 150 with respect to the main body 100 to open the storage room 140. The door opening device 160 may press the door 150 to open the door 150.

The door opening device 160 may be mounted on the main body 100. The door opening device 160 may be mounted on the top of the main body 100. For example, the door opening device 160 may be accommodated inside the top table 130 (see FIG. 3). An upper side of the door opening device 160 may be covered by the top table 130. The door opening device 160 may be positioned on an upper surface of the outer case 110.

The door opening device 160 may open the plurality of doors 150 independently. For example, the at least one door opening device 160 may include the first door opening device 160L for opening the first door 150L and the second door opening device 160R for opening the second door 150R.

The first door opening device 160L may rotate the first door 150L to open the first storage room 140a. The second door opening device 160R may rotate the second door 150R to open the second storage room 140b.

An operation in which the first door opening device 160L opens the first door 150L and an operation in which the second door opening device 160R opens the second door 150R may be performed independently from each other.

The first door opening device 160L and the second door opening device 160R may be arranged side by side with respect to each other in the horizontal direction Y. For example, the first door opening device 160L may be positioned to the left side with respect to a center at the top of the main body 100, and the second door opening device 160R may be positioned to the right side with respect to the center at the top of the main body 100. The first door opening device 160L mounted at the top of the main body 100 may press a top of the first door 150L, and the second door opening device 160R mounted at the top of the main body 100 may press a top of the second door 150R.

However, embodiments of the present disclosure are not limited thereto, and the door opening devices 160 may be installed at various locations of the main body 100 and press various parts of the first door 150L or the second door 150R instead of the top of the first door 150L or the second door 150R to open the first storage room 140a or the second storage room 140b. For example, unlike as shown in FIGS. 2 to 4, the door opening devices 160 may be mounted at a bottom of the main body 100 and press a bottom of the first door 150L or the second door 150R.

The first door opening device 160L and the second door opening device 160R may have corresponding structures. FIG. 4 shows in detail the structure of the first door opening device 160L configured to open the first door 150L, and the structure of the first door opening device 160L shown in FIGS. 4 and 5 may also be applied to the structure of the second door opening device 160R. The following descriptions about the structure of the door opening device 160 may be applied to both the structure of the first door opening device 160L and the structure of the second door opening device 160R.

The door opening device 160 may include a door pusher (e.g., a first door pusher 161a or a second door pusher 161b) that presses the door 150 to open the door 150. The door pusher (e.g., the first door pusher 161a or the second door pusher 161b) may be movable with respect to the main body 100. The door pusher (e.g., the first door pusher 161a or the second door pusher 161b) may press the door 150 while moving with respect to the main body 100. The door pusher (e.g., the first door pusher 161a or the second door pusher 161b) may press the door 150 while moving forward from the main body 100 toward the door 150, thereby opening the door 150 that is closed.

The door opening device 160 may include a pusher case 162 that supports the door pusher (e.g., the first door pusher 161a or the second door pusher 161b). The pusher case 162 may movably support the door pusher (e.g., the first door pusher 161a or the second door pusher 161b).

The pusher case 162 may form an accommodating space for accommodating at least a portion of the door pusher (e.g., the first door pusher 161a or the second door pusher 161b). The door pusher (e.g., the first door pusher 161a or the second door pusher 161b) may be movable between a position in which the door pusher (e.g., the first door pusher 161a or the second door pusher 161b) is maximally inserted into the accommodating space of the pusher case 162 and a position in which the door pusher (e.g., the first door pusher 161a or the second door pusher 161b) is withdrawn forward from the accommodating space of the pusher case 162.

The pusher case 162 may be mounted on the main body 100. The pusher case 162 may be fixed to the main body 100. For example, the pusher case 162 may be coupled to the top table 130. However, embodiments of the present disclosure are not limited thereto, and the pusher case 162 may be coupled to various locations of the main body 100.

The door opening device 160 may include a driver. The driver may provide a driving force to the door pusher (e.g., the first door pusher 161a or the second door pusher 161b) such that the door pusher (e.g., the first door pusher 161a or the second door pusher 161b) is movable with respect to the main body 100. The driver may move the door pusher (e.g., the first door pusher 161a or the second door pusher 161b) based on a door opening signal. Also, the driver may include a power source that generates power for opening the door 150. The power source may generate power for moving the door pusher (e.g., the first door pusher 161a or the second door pusher 161b). The power source may include a motor having various structures.

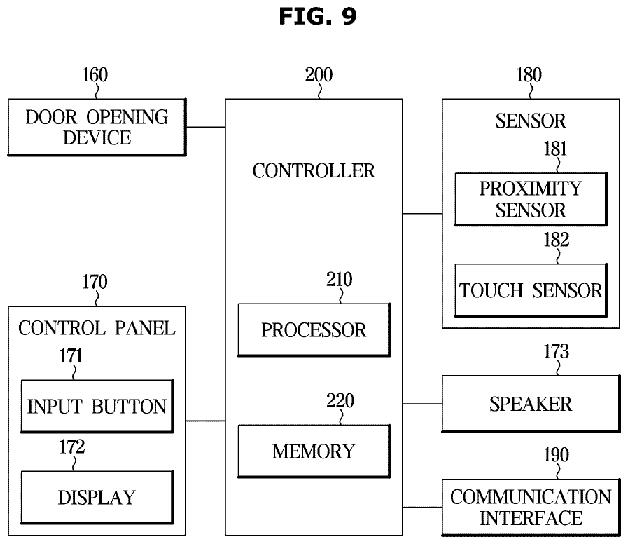

The door opening device 160 may be electrically connected to at least one processor 210 (see FIG. 9) of the refrigerator 11. The door opening device 160 may be controlled by the at least one processor 210 of the refrigerator 11. The door opening device 160 may operate based on a control signal received from the at least one processor 210. The door opening device 160 may include a circuit including various electronic components for moving the door pusher (e.g., the first door pusher 161a or the second door pusher 161b) based on a control signal.

Referring to FIGS. 4 and 5, the door opening device 160 may include a first door pusher 161a that is movable between a first pusher position P1 and a second pusher position P2. For example, the first door pusher 161a may be movable back and forth between the first pusher position P1 and the second pusher position P2. The first pusher position P1 may be a position of the first door pusher 161a while the door 150 is located at a closed position. The second pusher position P1 may be a position of the first door pusher 161a moved from the first pusher position P1 in a direction of pressing the door 150. The first door pusher 161a may move from the first pusher position P1 toward the second pusher position P2 and press the door 150, while closed, to open the door 150. The second pusher position P2 may be a position of the first door pusher 161a moved forward from the first pusher position P1.

While the first door pusher 161a is located at the first pusher position P1, the first door pusher 161a may be accommodated inside the top table 130. That is, while the first door pusher 161a is located at the first pusher position P1, the first door pusher 161a may be inserted in the top table 130, and the first door pusher 161a may be withdrawn from the top table 130 while moving from the first pusher position P1 to the second pusher position P2. The top table 130 may include an opening. The first door pusher 161a may penetrate the opening of the top table 130 to be movable between the first pusher position P1 and the second pusher position P2.

For example, the first door pusher 161a may be linearly movable between the first pusher position P1 and the second pusher position P2. The first door pusher 161a may be linearly movable back and forth with respect to the main body 100. The first door pusher 161a may be linearly movable in a front-rear direction X with respect to the main body 100. However, the first door pusher 161 may move non-linearly with respect to the main body 100.

By this configuration, the door opening device 160 may open the door 150.

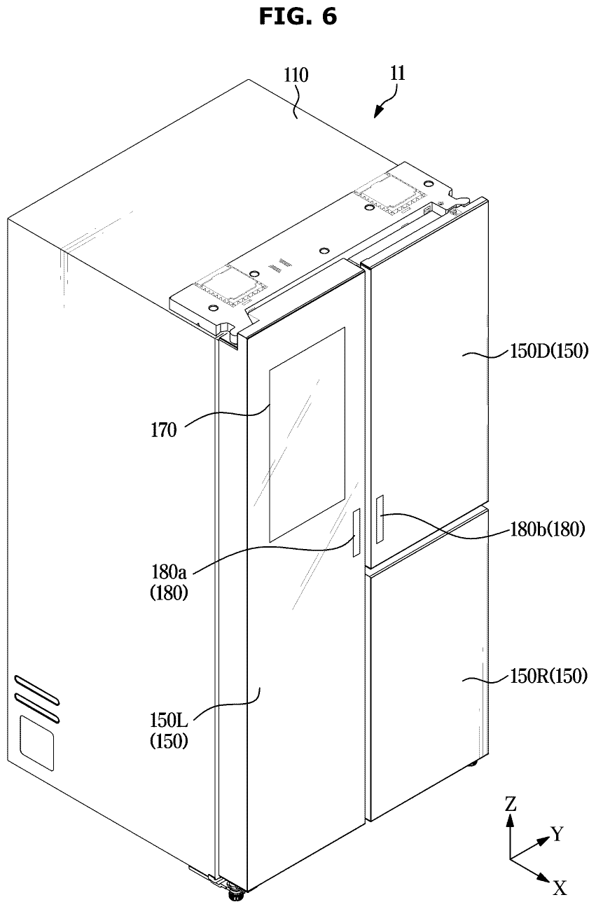

FIG. 6 is a perspective view showing an example of a refrigerator according to an embodiment when doors of the refrigerator are closed.

Referring to FIG. 6, the refrigerator 11 according to an embodiment of the present disclosure may further include a third door 150D. The third door 150D may be referred to as a “sub door”. For example, the third door 150D may be rotatable with respect to the second door 150R. The third door 150D may be rotatably coupled to the second door 150R. The second door 150R may have an opening, and the third door 150D may rotate with respect to the second door 150R to open or close the opening of the second door 150R.

For example, the opening of the second door 150R may be provided at an upper portion of the door frame 153 of the second door 150R. While the third door 150D opens the opening of the second door 150R, a user may access an upper area of the second storage room 140b or the door shelf 152 arranged at an inner side of an upper portion of the second door 150R. That is, according to an embodiment, the right door of the refrigerator 11 may be configured as a double door including the second door 150R and the third door 150D.

For example, the third door 150D may be provided with a handle, and a user may hold the handle with his or her hand and rotate the third door 150D with respect to the second door 150R to open the opening of the second door 150R.

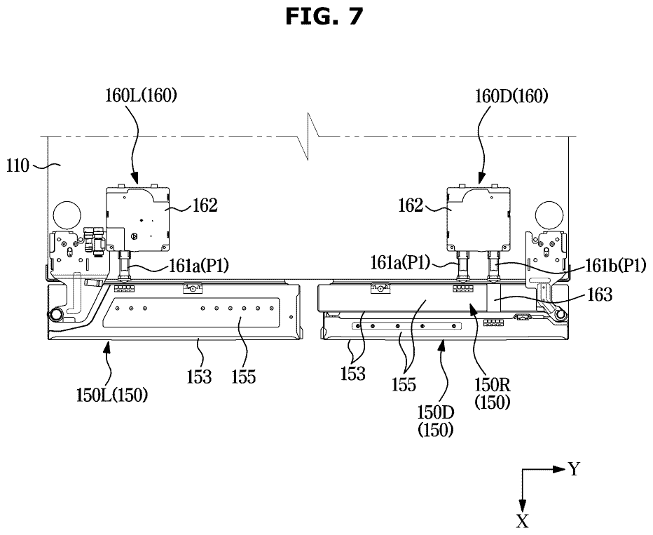

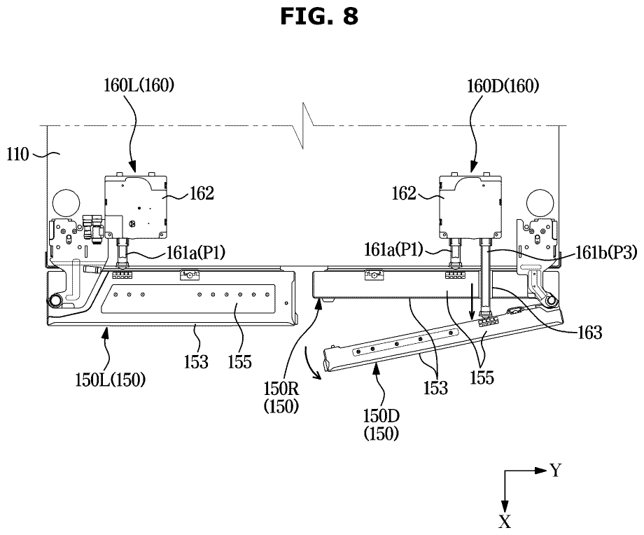

The second door 150R and the third door 150D may rotate independently with respect to the main body 100. For example, the second door 150R may be opened by a third door opening device 160D (see FIGS. 7-8) positioned at the right side. For example, the third door 150R may be opened by the third door opening device 160D positioned at the right side. For example, both the second door 150R and the third door 150D may be opened by the third door opening device 160D.

For example, the second door 150R or the third door 150D may include a sensor configured to obtain a signal for operating the third door opening device 160D. For example, the sensor configured to obtain a signal for operating the third opening device door 160D may include a second sensor 180b. The third door opening device 160D may operate to open at least one from among the second door 150R and the third door 150D based on a signal obtained by the second sensor 180b.

FIG. 7 is a top view of a refrigerator according to an embodiment when doors of the refrigerator are closed.

FIG. 8 is a top view of a refrigerator according to an embodiment when a door opening device opens a sub door of the refrigerator.

Referring to FIGS. 7 and 8, the third door opening device 160D may include the first door pusher 161a that is movable between the first pusher position P1 and the second pusher position P2, and a second door pusher 161b that is movable between the first pusher position P1 and a third pusher position P3. For example, the second door pusher 161b may be movable back and forth between the first pusher position P1 and the third pusher position P3.

The first pusher position P1 may be a position of the second door pusher 161b while the third door 150D is located at a closed position. While the second door pusher 161b is located at the first pusher position P1, the second door pusher 161b may be accommodated in the space of the top table 130. That is, while the second door pusher 161b is located at the first pusher position P1, the second door pusher 161b may be inserted in the top table 130, and the second door pusher 161b may be withdrawn from the top table 130 while moving from the first pusher position P1 to the third pusher position P3. The top table 130 may include the opening. The second door pusher 161b may penetrate the opening of the top table 130 to be movable between the first pusher position P1 and the third pusher position P3.

The third pusher position P3 may be a position of the second door pusher 161b that is in a direction of pressing the sub door (hereinafter, referred to as the “third door 150D”) from the first pusher position P1. The third door opening device 160D may further include a slot through which the second door pusher 161b moves by penetrating the first door 150R. According to various embodiments, in a case where the second door pusher 161b moves in the direction of pressing the third door 150D from a position spaced in a Z direction from the top of the second door 150R, the slot 163 may be omitted.

While the second door pusher 161b moves from the first pusher position P1 toward the third pusher position P3, the second door pusher 161b may press the third door 150D that is at a closed position and open the third door 150D. The third pusher position P3 may be a position of the second door pusher 161b that is in the front direction from the first pusher position P1.

For example, the first door pusher 161a may be linearly movable between the first pusher position P1 and the third pusher position P3. The second door pusher 161b may be linearly movable back and forth with respect to the main body 100. The second door pusher 161b may be linearly movable in the front-rear direction X with respect to the main body 100. However, in some embodiments, the second door pusher 161b may move non-linearly with respect to the main body 100.

FIG. 9 is a control block diagram of a refrigerator according to an embodiment.

Referring to FIG. 9, the refrigerator 11 may include the at least one door opening device 160, the control panel 170, the at least one sensor 180, a speaker 173, a communication interface 190, and/or a controller 200. The controller 200 may include at least one processor 210 and at least one memory 220.

According to various embodiments, the refrigerator 11 may implement various embodiments of the present disclosure. According to various embodiments, some of the components may be omitted from the refrigerator 11 or replaced in the refrigerator 11, and the refrigerator 11 may further include at least other component in addition to the above-described components.

The at least one door opening device 160 may automatically open or close the door 150 according to control by the at least one processor 210 as described above. The door opening device 160 may include a motor drive and a driving motor. Also, the door opening device 160 may include a motor drive and a driving motor. Also, the door opening device 160 may further include a plurality of gears that transfer a rotation of the driving motor to a hinge of the refrigerator 11.

The motor drive may receive a target speed command or a torque command from the at least one processor 210, and provide driving current corresponding to the target speed command or the target torque command to the driving motor. For example, the motor drive may apply a pulse-width modulated driving voltage to the driving motor to provide driving current to the driving motor. The driving motor may generate torque to open or close the door 150. The driving motor may include, for example, a brushless direct current motor (BLDC motor) or a permanent magnet synchronous motor (PMSM) of which a rotational speed is easily controlled.

The control panel 170 may provide a user with a user interface for interactions with the user. The control panel 170 may be provided on the main body 100 or the door 150. For example, the control panel 170 may be provided on an outer side of the first door 150L.

The control panel 170 may include at least one input button 171 and/or a display 172.

The input button 171 may receive a user input related to an operation of the refrigerator 11. For example, the input button 171 may receive a user input (or a user command) for opening the door 150. For example, the input button 171 may receive a target refrigerating temperature for controlling a temperature of the storage room 140 or a target freezing temperature for controlling a temperature of the storage room 140.

The input button 171 may provide an electrical signal (user input signal) (e.g., a voltage signal or a current signal) corresponding to a user input to the at least one processor 210. The at least one processor 210 may identify the user input by processing the user input signal.

The input button 171 may include a tact switch, a push switch, a slide switch, a toggle switch, a micro switch, or a touch switch.

The display 172 may obtain operation information of the refrigerator 11 from the at least one processor 210 and display the operation information of the refrigerator 11. For example, the display 172 may display opening or closing of the door 150. For example, the display 172 may display a measured temperature of the refrigerating room or a measured temperature of the freezing room.

Also, the display 172 may display a user input obtained in relation to an operation of the refrigerator 11. For example, the display 172 may display a user input for opening the door 150. For example, the display 172 may display a target refrigerating temperature of the refrigerating room or a target freezing temperature of the freezing room, obtained through the input button 171.

The display 172 may include, for example, a liquid crystal display (LCD) panel, a light emitting diode (LED) panel, etc.

The sensor 180 may detect an external object or an input from an external object. For example, the sensor 180 may detect a user or an input from a user.

The sensor 180 may include a touch sensor 182 that detects a physical characteristic changing by a user's touch. In this case, detecting the user's touch by the touch sensor 182 may include identifying a strength of the user's touch or a strength of pressure applied by the user based on the changing physical characteristic. For example, the touch sensor 182 may include a pressure-sensitive touch sensor that detects a change in pressure by a user's touch. The pressure-sensitive touch sensor may detect a change in pressure applied by a user to the touch sensor 182 based on a change in resistance. For example, the touch sensor 182 may include a capacitive touch sensor that detects a change in electric capacity by a user's touch. For example, the touch sensor 182 may include a piezoelectric touch sensor that obtains an electrical signal generated from a piezoelectric material according to a change in pressure applied by a user's touch. For example, a touch sensor 182 may include an optical touch sensor that detects a degree of light blocking according to a user's touch.

The sensor 180 may include a proximity sensor 181 that identifies presence of a user located around the refrigerator 11 and identifies a distance to the user. The proximity sensor 181 may detect a physical characteristic that changes by a user's approach to the proximity sensor 181. At this time, detecting the user's approach by the proximity sensor 181 may include identifying a change in distance between the proximity sensor 181 and the user based on the changing physical characteristic. For example, the proximity sensor 181 may include a capacitive proximity sensor that detects a user's approach based on a change in electric capacitance according to the user's approach. Because a change in an electric field may occur even without direct contact by the user, contactless detection may be possible. For example, the proximity sensor 181 may include an ultrasonic proximity sensor that transmits ultrasonic waves and detects a user's approach based on a change in Time of Flight (ToF) of an echo signal reflected from the user. For example, the proximity sensor 181 may include an ultrasonic proximity sensor that transmits infrared light and detects a user's approach based on a change in ToF of an infrared signal reflected from the user. The proximity sensor 181 may include a magnetic proximity sensor that detects a user's approach based on a change in magnetic field caused by the user's approach.

According to various embodiments, the refrigerator 11 may further include various kinds of sensors capable of obtaining information related to movements of objects, in addition to the above-described sensors.

The speaker 173 may provide information related to an operation of refrigerator 11 in the form of auditory information. For example, the speaker 173 may provide information regarding whether the door 150 operates and an operation state of the door 150 through an effect sound. As another example, the speaker 173 may provide information regarding a location of the door 150 to be opened and/or a time at which the door 150 opens, through a voice. In this case, an output interface may provide information regarding an operation of the refrigerator 11 to a user through sensory information. For example, the output interface may include the display 172 and/or the speaker 173.

The communication interface 190 may include one or more components that enable communication with an external device, and may include, for example, at least one from among a short-range communication module, a wired communication module, and a wireless communication module. The external device may include the user device 2, the server device 3, or another refrigerator 11.

The communication interface 190 may perform communication through a network or by using a short-range wireless communication method. For example, the communication interface 190 may perform communication by using any one of wireless data communication methods including Wireless LAN, Wi-Fi, Bluetooth, Zigbee, Wi-Fi Direct (WFD), Infrared Data Association (IrDA), Bluetooth LowEnergy (BLE), Near Field Communication (NFC), Wireless Broadband Internet (Wibro), World Interoperability for Microwave Access (WiMAX), Shared Wireless Access Protocol (SWAP), Wireless Gigabit Alliance (WiGig), RF communication, 60 GHz millimeter wave (mm Wave) short-range communication, etc.

The at least one processor 210 of the controller 200 may be mounted on a printed circuit board provided inside the door 150 such as, for example, or on a printed circuit board provided inside a housing.

The at least one processor 210 may be operatively or electrically connected to the at least one door opening device 160, the control panel 170, the at least one sensor 180, the speaker 173, and the communication interface 190.

The at least one processor 210 may process an output signal from the at least one sensor 180 and output a control signal for controlling the at least one door opening device 160.

The at least one processor 210 may include the at least one memory 220 that stores or memorizes a program (a plurality of instructions) or data for processing a signal and providing a control signal. The memory 220 may include volatile memory, such as a static random access memory (S-RAM) and a dynamic random access memory (D-RAM), and non-volatile memory, such as a read only memory (ROM) and an erasable programmable read only memory (EPROM). The at least one memory 220 may be integrated into the at least one processor 210 or may be provided as a semiconductor device separated from the at least one processor 210.

The at least one processor 210 may further include a processing core (e.g., an arithmetic circuit, a memory circuit, and a control circuit) that processes a signal and outputs a control signal based on the program or data stored in the at least one memory 220.

The at least one processor 210 may process a user input signal from the control panel 170 and identify a user input. For example, the at least one processor 210 may identify a user input for opening the door 150 or a user input for closing the door 150. The at least one processor 210 may control the door opening device 160 to open or close the door 150 based on a user input signal from the control panel 170.

Also, the at least one processor 210 may control the at least door opening device 160 to open or close the first door 150L and the second door 150R independently from each other based on a user input signal from the control panel 170. Also, the at least one processor 210 may control the at least one door opening device 160 to open or close the second door 150R and the third door 150D independently from each other based on a user input signal from the control panel 170.

The at least one processor 210 may process an output signal obtained from the at least one sensor 180 to generate a processing signal, generate a trigger signal based on an intensity of the processing signal being greater than or equal to a preset threshold value, determine to open a plurality of doors 150 including a door 150 provided with the sensor 180 among the plurality of doors 150 based on a generation pattern of the trigger signal for a reference time, and control the at least one door opening device 160 to open the plurality of doors 150 that have been determined for opening.

The at least one processor 210 may determine to open the plurality of doors 150 including the door 150 provided with the sensor 180 among the plurality of doors 150, based on the trigger signal being continuously generated for a first reference time.

The at least one processor 210 may extract, based on the trigger signal being intermittently generated for a second reference time, a trigger signal generation section in which the trigger signal is continuously generated for a preset threshold time or longer among trigger signal generation sections generated within the second reference time, and may determine, based on the number of the extracted trigger signal generation section being greater than or equal to a preset number, to open the plurality of doors 150 including the door 150 provided with the sensor 180 among the plurality of doors 150.

The at least one processor 210 may identify at least one door 150 excluding the door 150 provided with the sensor 180 from among the plurality of doors 150 that have been determined for opening, based on the number of the extracted trigger signal generation section.

The at least one processor 210 may control the at least one door opening device 160 to simultaneously or sequentially open the plurality of doors 150 that have been determined for opening.

The at least one processor 210 may control the output interface to output a notification informing a user of opening, before opening the plurality of doors 150 that have been determined for opening. The output interface may provide the user with information regarding an operation of the refrigerator 11 through sensory information. For example, the output interface may include the display 172 and/or the speaker 173.

The at least one processor 210 may control, before opening the plurality of doors 150 that have been decided to be opened, the communication interface 190 to transmit a notification output signal to an external device such that the external device outputs a notification informing a user of opening. In this case, the external device may include the user device 2, the server device 3, and/or another refrigerator 11.

The at least one processor 210 according to an embodiment may process an output signal obtained from a sensor 180 to generate a processing signal, generates a trigger signal based on an intensity of the processing signal being greater than or equal to the preset threshold value, determine to open a plurality of doors 150 including one door among the plurality of doors 150 based on a generation pattern of the trigger signal for the reference time, and control a plurality of door opening devices 160 for opening the plurality of doors 150 that have been determined for opening among the plurality of door opening devices 160.

The at least one processor 210 may determine, based on the trigger signal being continuously generated for the first reference time, to open the plurality of doors 150 including the one door 150 among the plurality of doors 150.

The at least one processor 210 may extract, based on the trigger signal being intermittently generated for the second reference time, a trigger signal generation section in which the trigger signal is continuously generated for the preset threshold time or longer among trigger signal generation sections generated in the second reference time, and may determine, based on the number of the extracted trigger signal generation section being greater than or equal to the preset number, to open the plurality of doors 150 including the one door 150 among the plurality of doors 150.

The at least one processor 210 may identify at least one door 150 excluding the one door 150 from among the plurality of doors 150 that have been determined for opening, based on the number of the extracted trigger signal generation section.

The at least one processor 210 may control the plurality of door opening devices 160 for opening the plurality of doors 150 that have been determined for opening to simultaneously or sequentially open the plurality of doors 150.

The at least one processor 210 may control the output interface to output a notification informing the user of opening, before opening the plurality of doors 150 that have been determined for opening.

In this case, the output interface may include the display 172 and/or the speaker 173.

The at least one processor 210 may control, before opening the plurality of doors 150 that have been determined for opening, the communication interface 190 to transmit a notification output signal to an external device such that the external device outputs a notification informing the user of opening. In this case, the external device may include the user device 2.

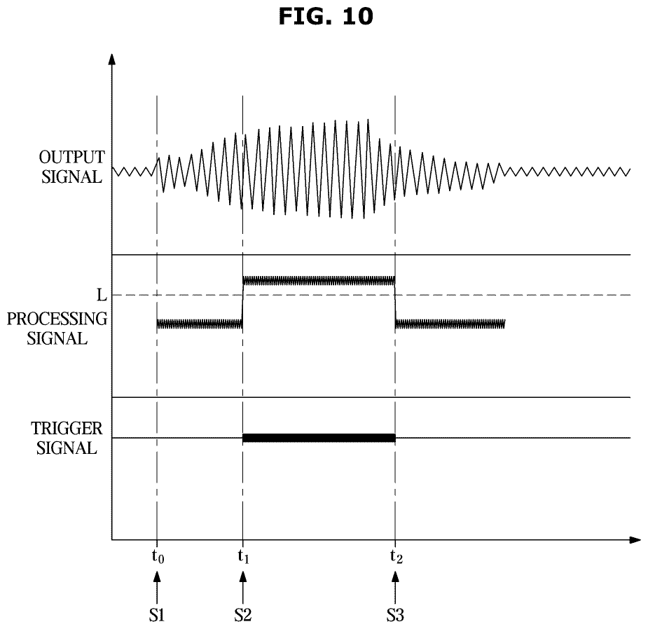

FIG. 10 is a diagram for describing an example of a method of processing an output signal obtained from a sensor included in a refrigerator according to an embodiment.

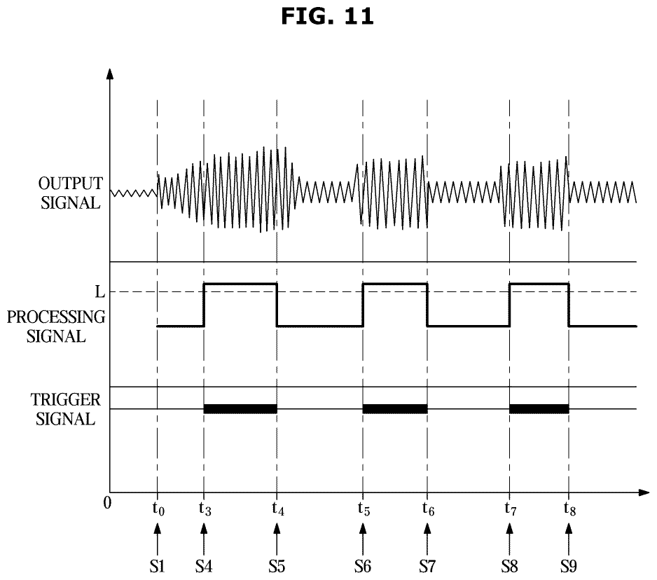

FIG. 11 is a diagram for describing another example of a method of processing an output signal obtained from a sensor included in a refrigerator according to an embodiment.

In FIGS. 10 and 11, an x axis may represent time, and a y axis may represent intensities of an output signal, a processing signal, and a trigger signal for a preset time.

The sensor 180 of the refrigerator 11 according to an embodiment may obtain, as an input signal, a physical characteristic that changes according to a user's touch or a user's approach, and convert the input signal into a digital signal to generate an output signal.

The at least one processor 210 of the refrigerator 11 according to an embodiment may generate a processing signal by processing an output signal obtained from the sensor 180. The at least one processor 210 may generate a trigger signal based on an intensity of the processing signal being greater than or equal to a preset threshold value. The at least one processor 210 may determine, based on a generation pattern of the trigger signal for a reference time, to open a plurality of doors 150 including a door 150 provided with the sensor 180 among the plurality of doors 150. At this time, the sensor 180 of the door 150 provided with the sensor 180 may be the sensor 180 that has generated the output signal for generating the trigger signal.

The output signal may be a signal obtained by converting a physical characteristic that is obtained in the form of an analog signal by the sensor 180 and changes according to a user's touch or a user's approach, into a digital signal. The output signal may be provided from the sensor 180 to the at least one processor 210.

The processing signal may include a signal obtained by processing the output signal according to a specific algorithm or logical operation by the at least one processor 210. For example, the processing signal may include a digital data signal configured with bits of 0 and 1. For example, in a case where an intensity of an output signal obtained from the sensor 180 is greater than or equal to a preset intensity, the at least one processor 210 may generate a signal of “1.” Also, in a case where an intensity of an output signal obtained from the sensor 180 is less than the preset intensity, the processor 210 may generate a signal of “0.” According to various embodiments, the processing signal may be generated in the form of a pulse signal. According to various embodiments, the sensor 180 may generate the processing signal and provide the processing signal to the at least one processor 210 according to a method in which the at least one processor 210 generates a processing signal.

The trigger signal may include a signal obtained by processing the processing signal according to a specific algorithm or logical operation by the at least one processor 210. The at least one processor 210 may determine to open the plurality of doors 150 based on the trigger signal. Accordingly, the at least one processor 210 may control the at least one door opening device 160 based on the trigger signal.

For example, the at least one processor 210 may generate a trigger signal based on an intensity of a processing signal being greater than or equal to a preset threshold value L of FIGS. 10 and 11. For example, the preset threshold value may correspond to a value between 0 and 1. Accordingly, the at least one processor 210 may generate a trigger signal based on the processing signal being greater than or equal to the threshold value L.

More specifically, referring to FIG. 10, t₀ may correspond to a time S1 at which the sensor 180 detects a user or a user input to obtain an input signal and provides an output signal to the at least one processor 210. A time section of t₀ to t₁ may correspond to a section in which, based on an intensity of the output signal being less than the preset intensity when the sensor 180 detects the user or the user input and outputs the output signal to the at least one processor 210, a processing signal of “0” is generated. T₁ may correspond to a time S2 at which an intensity of the output signal corresponds to the preset intensity and a processing signal of “1” is generated. A time section of t₁ to t₂ may correspond to a section in which, based on an intensity of the output signal being greater than or equal to the preset intensity, a processing signal of “1” is generated. T₂ may correspond to an end point (e.g., time S3) at which the intensity of the output signal corresponds to the preset intensity and the processing signal of “1” is generated. A section after t₂ may correspond to a section in which, based on an intensity of the output signal being less than the preset intensity, a processing signal of “0” is generated. Accordingly, in the time section of t₁ to t₂, a trigger signal may be continuously generated.

Referring to FIG. 11, t₀ may correspond to a time S1 at which the sensor 180 detects a user or a user input to obtain an input signal and provides an output signal to the at least one processor 210. A time section of t₀ to t₃ may correspond to a section in which, based on an intensity of the output signal being less than a preset intensity when the sensor 180 detects the user or the user input and outputs the output signal to the at least one processor 210, a processing signal of “0” is generated. T₃ may correspond to a time S4 at which an intensity of the output signal corresponds to the preset intensity and a processing signal of “1” is generated. A time section of t₃ to t₄ may correspond to a section in which, based on an intensity of the output signal being greater than or equal to the preset intensity, a processing signal of “1” is generated. T₄ may correspond to an end point S5 at which the intensity of the output signal corresponds to the preset intensity and the processing signal of “1” is generated. A time section of t₄ to t₅ may correspond to a section in which, based on an intensity of the output signal being less than the preset intensity, a processing signal of “0” is generated. T₅ may correspond to a time S6 at which an intensity of the output signal corresponds to the preset intensity and a processing signal of “1” is generated. A time section of t₅ to t₆ may correspond to a section in which, based on an intensity of the output signal being greater than or equal to the preset intensity, a processing signal of “1” is generated. T₆ may correspond to an end point S7 at which the intensity of the output signal corresponds to the preset intensity and the processing signal of “1” is generated. A time section of t₆ to t₇ may correspond to a section in which, based on an intensity of the output signal being less than the preset intensity, a processing signal of “0” is generated. T₇ may correspond to a time S8 at which an intensity of the output signal corresponds to the preset intensity and a processing signal of “1” is generated. A time section of t₇ to t₈ may correspond to a section in which, based on an intensity of the output signal being greater than or equal to the preset intensity, a processing signal of “1” is generated. T₈ may correspond to an end point S9 at which the intensity of the output signal corresponds to the preset intensity and the processing signal of “1” is generated.

A section after t₈ may correspond to a section in which, based on intensity of the output signal being less than the preset intensity, a processing signal of “0” is generated. Accordingly, the trigger signal may be intermittently generated in three sections for the reference time. That is, the trigger signal may be continuously generated in the time section from t₃ to t₄, the time section from t₅ to t₆, and the time section from t₇ to t₈.

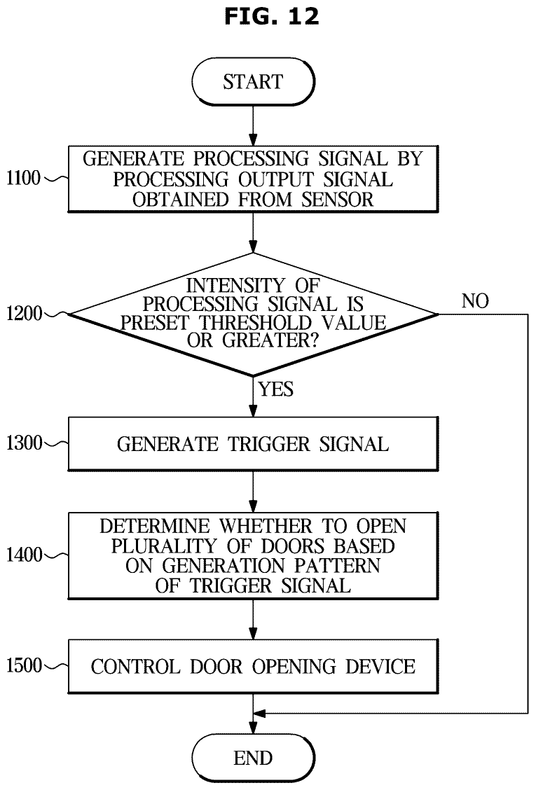

FIG. 12 is a control flowchart of a refrigerator according to an embodiment.

The at least one processor 210 according to an embodiment may generate a processing signal by processing an output signal obtained from the sensor 180 (operation 1100). According to various embodiments, the sensor 180 may generate a processing signal by processing an output signal and provide the processing signal to the at least one processor 210.

For example, in the refrigerator 11 including the first door 150L and the second door 150R as shown in FIG. 2, the at least one processor 210 may generate a processing signal by processing an output signal obtained from the first sensor 180a provided on the first door 150L.

Also, in the refrigerator 11 including the first door 150L, the second door 150R, and the third door 150D as shown in FIG. 6, the at least one processor 210 may generate a processing signal by processing an output signal obtained from the first sensor 180a provided on the first door 150L.

The at least one processor 210 may identify whether an intensity of the processing signal is equal to or greater than a preset threshold value (operation 1200).

According to the intensity of the processing signal being less than the preset threshold value (NO in operation 1200), no trigger signal may be generated and the door 150 may be maintained in a closed state. For example, as shown in FIG. 2, the first door 150L and the second door 150R may be maintained in a closed state. For example, as shown in FIG. 4, according to the first door pushers 161a of the first door opening device 160L and the second door opening device 160R being located at the first door pusher position P1, no pressure may be applied to the first door 150L and the second door 150R. Also, as shown in FIG. 6, the first door 150L, the second door 150R, and the third door 150D may be maintained in a closed state. For example, as shown in FIG. 7, according to the first door pusher 161a of the first door opening device 160L and the first door pusher 161a and the second door pusher 161b of the third door opening device 160D being located at the first door pusher position P1, no pressure may be applied to the first door 150L, the second door 150R, and the third door 150D.

According to the intensity of the processing signal being greater than or equal to the preset threshold value (YES in operation 1200), the at least one processor 210 may generate a trigger signal (operation 1300).

The at least one processor 210 may determine whether to open the plurality of doors 150 based on a generation pattern of the trigger signal (operation 1400). The plurality of doors 150 may include a door 150 provided with the sensor 180 that has provided the output signal to the at least one processor 210, and at least one remaining door. For example, in the refrigerator 11 of FIG. 2, the at least one processor 210 may determine to open the first door 150L provided with the first sensor 180a and the second door 150R, based on a generation pattern of the trigger signal. For example, in the refrigerator 11 of FIG. 6, the at least one processor 210 may determine, based on a generation pattern of the trigger signal, to open the first door 150L provided with the first sensor 180a and at least one from among the second door 150R and the third door 150D.

Also, the at least one door 150 excluding the door 150 provided with the sensor 180 that has provided the output signal to the at least one processor 210, among the plurality of doors 150 that have been determined for opening may have been set in advance based on a user input signal. For example, in the refrigerator 11 of FIG. 6, when the at least one processor 210 opens the plurality of doors 150 including the first door 150L, the at least one processor 210 may receive a user command for automatically opening at least one from among the second door 150R and the third door 150D together with the first door 150L through the input button 171. At this time, in the refrigerator 11, when the at least one processor 210 automatically opens the plurality of doors 150 including the first door 150L, the at least one processor 210 may receive, through the input button 171, a user command regarding whether to open at least one from among the second door 150R and the third door 150D simultaneously or sequentially with the first door 150L.

The at least one processor 210 may control the at least one door opening device 160 to open the plurality of doors 150 that have been determined for opening. Accordingly, the plurality of doors 150 that have been determined for opening may rotate. At this time, the plurality of doors 150 that have been determined for opening may be opened simultaneously or sequentially.

At this time, the at least one processor 210 may control the output interface to provide a user with information related to opening of the plurality of doors 150. The output interface may include the display 172 that provides visual information and/or the speaker 173 that provides aural information. For example, the at least one processor 210 may control the output interface to output a notification informing opening, before opening each door 150.

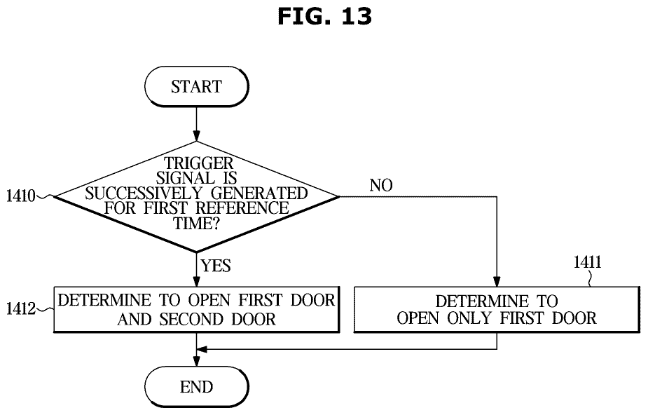

FIG. 13 is an example of a control flowchart for identifying a door to be automatically opened in a refrigerator, according to an embodiment.

Hereinafter, a case where the first sensor 180a provided on the first door 150L provides an output signal to the at least one processor 210 will be described as an example. However, embodiments of the present disclosure are not limited thereto, and embodiments of the present disclosure may also be applied in the same way to a case where the sensor 180 provided on another door excluding the first door 150L among the plurality of doors 150 provides an output signal to the at least one processor 210.

According to an embodiment, the at least one processor 210 may identify whether a trigger signal is continuously generated for a first reference time (operation 1410). The first reference time may have been set in advance and stored in the at least one memory 220. For example, referring to FIG. 10, whether a trigger signal is continuously generated for the first reference time from the time S2 at which the trigger signal starts being continuously generated may be identified.

According to the trigger signal not being continuously generated for the first reference time (NO in operation 1410), the at least one processor 210 may determine to open only the first door 150L (operation 1411).

Meanwhile, according to the trigger signal being continuously generated for the first reference time (YES in operation 1410), the at least one processor 210 may determine to open a plurality of doors 150 including the first door 150L (operation 1412). For example, referring to FIG. 10, in a case where a time until which a trigger signal is continuously generated from the time S2 at which the trigger signal starts to be continuously generated is time S3, the at least one processor 210 may determine to open the first door 150L and the second door 150R.

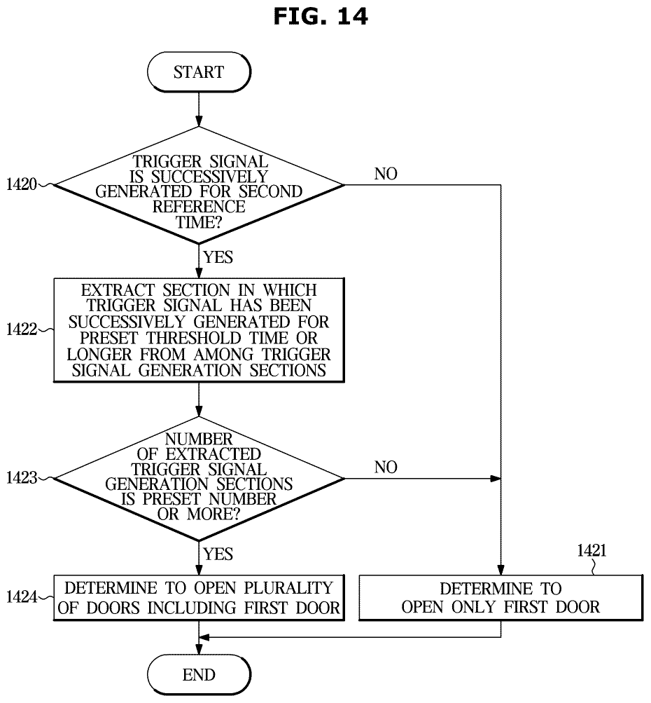

FIG. 14 is another example of a control flowchart for identifying a door to be automatically opened in a refrigerator, according to an embodiment.

Hereinafter, a case where the first sensor 180a provided on the first door 150L provides an output signal to the at least one processor 210 will be described as an example. However, embodiments of the present disclosure are not limited thereto, and embodiments of the present disclosure may also be applied in the same way to a case where the sensor 180 provided on another door 150 excluding the first door 150L among the plurality of doors 150 provides an output signal to the at least one processor 210.

According to an embodiment, the at least one processor 210 may identify whether a trigger signal is intermittently generated for a second reference time (operation 1420). The second reference time may have been set in advance and stored in the at least one memory 220. For example, referring to FIG. 11, whether a trigger signal is continuously generated for the second reference time from the time S4 at which the trigger signal starts being intermittently generated may be identified.

According to the trigger signal not being intermittently generated for the second reference time (NO in operation 1420), the at least one processor 210 may determine to open only the first door 150L (operation 1421).

Meanwhile, according to the trigger signal being intermittently generated for the second reference time (YES in operation 1420), the at least one processor 210 may extract a trigger signal generation section in which the trigger signal has been continuously generated for a preset threshold time or longer from among at least one trigger signal generation sections (operation 1422). For example, in FIG. 11, in a case where the preset threshold time is T and time lengths of sections t₃-t₄, t₅-t₆, and t₇-t₈ in which the trigger signal is continuously generated are in the order of t₇-t₈<t₃-t₄<t₅-t₆, the at least one processor 210 may extract the trigger signal generation sections t₃-t₄ and t₅-t₆ in which the trigger signal is continuously generated for the preset threshold time or longer from among the trigger signal generation sections.

The at least one processor 210 may identify whether the number of the extracted trigger signal generation sections is equal to or greater than a preset number (operation 1423).

According to the number of the extracted trigger signal generation sections being less than the preset number (NO in operation 1423), the at least one processor 210 may determine to open only the first door 150L (operation 1421).

Meanwhile, according to the number of the extracted trigger signal generation sections being greater than or equal to the preset number (YES in operation 1423), the at least one processor 210 may determine to open the plurality of doors 150 including the first door 150L (1424). For example, in a case where the preset number of trigger signal generation sections is two, the at least one processor 210 may determine to open the plurality of doors 150 including the first door 150L because t₃-t₄ and t₅-t₆ have been extracted.

Also, according to the at least one processor 210 determining to open the plurality of doors 150 including the first door 150L, the at least one processor 210 may identify at least one door 150 excluding the first door 150L from among the plurality of doors 150 that have been determined for opening, based on the number of the extracted trigger signal generation sections. The number of extracted trigger signal generation sections corresponding to each of the plurality of doors 150 may have been set in advance and stored in the at least one memory 220. For example, in a case where a preset number of trigger signal generation sections has been set to two in the refrigerator 11 of FIG. 6, the number of extracted trigger signal generation sections which is two may have been set in advance to open the second door 150R and stored in the at least one memory 220, and the number of extracted trigger signal generation sections which is three may have been set in advance to open the third door 150D and stored in the at least one memory 220. Accordingly, in a case where a preset number of trigger signal generation sections has been set to two, the at least one processor 210 may determine to open the first door 150L and the second door 150R.

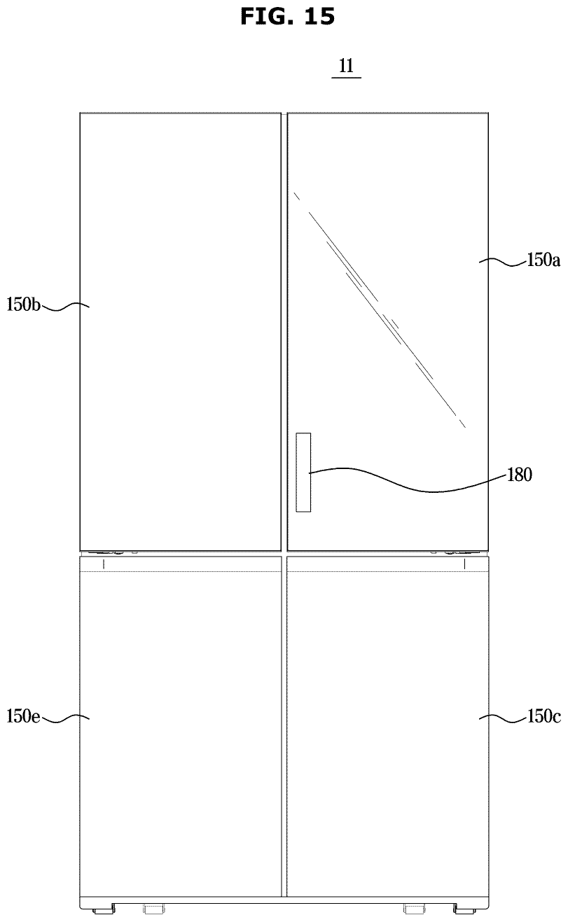

FIG. 15 shows an example of a refrigerator according to an embodiment.

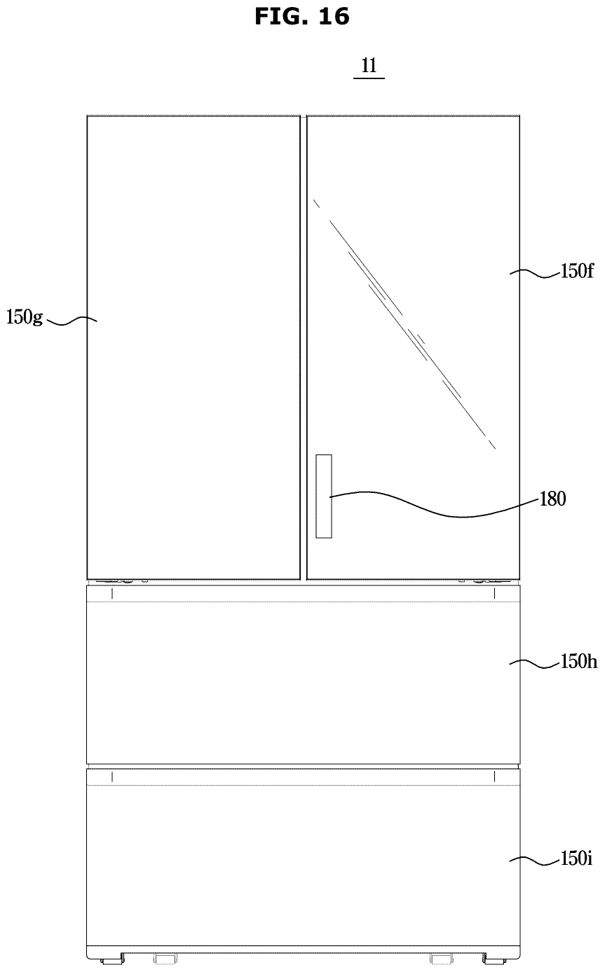

FIG. 16 shows an example of a refrigerator according to an embodiment.

The refrigerator 11 according to an embodiment may include four doors 150 as shown in FIGS. 15 and 16, unlike the refrigerator 11 shown in FIG. 2 or 6.

Referring to FIG. 15, the refrigerator 11 according to an embodiment may include a fourth door 150a, a fifth door 150b, a sixth door 150c, a seventh door 150e, and the sensor 180 provided on any one from among the fourth door 150a, the fifth door 150b, the sixth door 150c, and the seventh door 150e. In this case, the fourth door 150a and the fifth door 150b may be arranged in the horizontal direction Y with respect to each other, and the sixth door 150c and the seventh door 150e may be arranged in the horizontal direction Y with respect to each other. The fourth door 150a and the sixth door 150c may be arranged in the vertical direction Z with respect to each other, and the fifth door 150b and the seventh door 150c may be arranged in the vertical direction Z with respect to each other.

The sensor 180 may detect a user or a user input, receive, as an input signal, a physical characteristic that changes by the user, convert the input signal into an output signal, and provide the output signal to the at least one processor 210. Hereinafter, a case where the sensor 180 is provided on the fourth door 150a will be described as an example. However, embodiments of the present disclosure may also be applied in the same way to a case where the sensor 180 is provided on any one door 150 from among the fifth door 150b, the sixth door 150c, and the seventh door 150e.

The at least one processor 210 may determine whether to open the plurality of doors 150 including the fourth door 150a, based on a generation pattern of a trigger signal obtained from the output signal obtained from the sensor 180.

For example, the at least one processor 210 may determine to open the fourth door 150a and the fifth door 150b arranged side by side with the fourth door 150a in the horizontal direction Y. The at least one processor 210 may determine to simultaneously or sequentially open the fourth door 150a and the fifth door 150b. Accordingly, the at least one processor 210 may control a plurality of door opening devices 160 that respectively open the fourth door 150a and the fifth door 150b.

For example, the at least one processor 210 may determine to open the fourth door 150a and the seventh door 150e arranged side by side with the fourth door 150a in the vertical direction Z. The at least one processor 210 may determine to simultaneously or sequentially open the fourth door 150a and the seventh door 150e. Accordingly, the processor 210 may control a plurality of door opening devices 160 that respectively open the fourth door 150a and the seventh door 150e.

According to various embodiments, the refrigerator 11 may include the fourth door 150a, the fifth door 150b, the sixth door 150c, the seventh door 150e, and two sensors 180 respectively provided on any two from among the fourth door 150a, the fifth door 150b, the sixth door 150c, and the seventh door 150e.

As another example, the sensor 180 may be provided on each of the fourth door 150a and the sixth door 150c, or the sensor 180 may be provided on each of the fifth door 150b and the seventh door 150e. Hereinafter, a case where the sensor 180 is provided on each of the fourth door 150a and the sixth door 150c will be described as an example. However, embodiments of the present disclosure may also be applied in the same way to a case where the sensor 180 is provided on each of the fifth door 150b and the seventh door 150e.

The at least one processor 210 may determine, based on an output signal obtained from the sensor 180 provided on the fourth door 150a, to open the fourth door 150a and the fifth door 150b arranged side by side with the fourth door 150a in the horizontal direction Y. The at least one processor 210 may determine, based on an output signal obtained from the sensor 180 provided on the sixth door 150c, to open the sixth door 150c and the seventh door 150e arranged side by side with the sixth door 150c in the horizontal direction Y. All of the plurality of doors 150 may be opened based on a number of sensors 180 that is less than the number of the doors 150.

As another example, the sensor 180 may be provided on each of the fourth door 150a and the fifth door 150b, or the sensor 180 may be provided on each of the sixth door 150c and the seventh door 150e. Hereinafter, a case where the sensor 180 is provided on each of the fourth door 150a and the fifth door 150b will be described as an example. However, embodiments of the present disclosure may also be applied in the same way to a case where the sensor 180 is provided on each of the sixth door 150c and the seventh door 150e.

The at least one processor 210 may determine, based on an output signal obtained from the sensor 180 provided on the fourth door 150a, to open the fourth door 150a and the sixth door 250c arranged side by side with the fourth door 150a in the vertical direction Z. The processor 210 may determine, based on an output signal obtained from the sensor 180 provided on the fifth door 150a, to open the fifth door 150a and the seventh door 150e arranged side by side with the fifth door 150b in the vertical direction Y.

All of the plurality of doors 150 may be opened by a number of sensors 180 that is less than the number of the doors 150.

In a case where the sensor 180 is provided on each of the plurality of doors 150 arranged side by side in the vertical direction Z, a situation in which, when a user approaches or touches a door 150 at the upper position, a sensor (e.g., a proximity sensor 181) of another door 150 located at the lower position detects the user by the user's lower body and thus, the other door 150 opening may occur. As in this situation, a false positive in which a sensor detects a signal that does not need to be detected may occur. Meanwhile, in the case where the sensor 180 is provided on each of the plurality of doors 150 arranged side by side in the horizontal direction Y, user inconvenience due to a false positive that may occur in the case where the sensor 180 is provided on each of the plurality of doors arranged side by side in the vertical direction Z may be reduced.

Referring to FIG. 16, the refrigerator 11 according to an embodiment may include an eighth door 150f, a ninth door 150g, a tenth door 150h, an eleventh door 150i, and the sensor 180 provided on any one door 150 from among the eighth door 150f, the ninth door 150g, the tenth door 150h, and the eleventh door 150i. In this case, the eighth door 150f and the ninth door 150g may be arranged side by side in the horizontal direction Y. The tenth door 150h and the eleventh door 150i may be arranged side by side with the eighth door 150f and the ninth door 150g in the vertical direction Z.

The sensor 180 may detect a user or a user input, receive, as an input signal, a physical characteristic that changes by the user, convert the input signal into an output signal, and provide the output signal to the at least one processor 210. Hereinafter, a case where the sensor 180 is provided on the eighth door 150f will be described as an example. However, embodiments of the present disclosure may also be applied in the same way to a case where the sensor 180 is provided on any one door 150 from among the ninth door 150g, the tenth door 150h, and the eleventh door 150i.

The at least one processor 210 may determine whether to open the plurality of doors 150 including the eighth door 150f, based on a generation pattern of a trigger signal obtained from the output signal obtained from the sensor 180.

For example, the at least one processor 210 may determine to open the eighth door 150f and the eleventh door 150i located at a relatively lower portion of the refrigerator 11. The at least one processor 210 may determine to simultaneously or sequentially open the eighth door 150f and the eleventh door 150i. Accordingly, the at least one processor 210 may control a plurality of door opening devices 160 that respectively open the eighth door 150f and the eleventh door 150i.

Accordingly, all of the plurality of doors 150 may be opened by a number of sensors 180 that is less than the number of the doors 150.

Also, because a door 150 such as the eleventh door 150i, which is located at the relatively lower position of the refrigerator 11 and thus difficult for a user to open by holding the handle 154, is automatically opened through the user's touch or approach, user convenience may be improved.

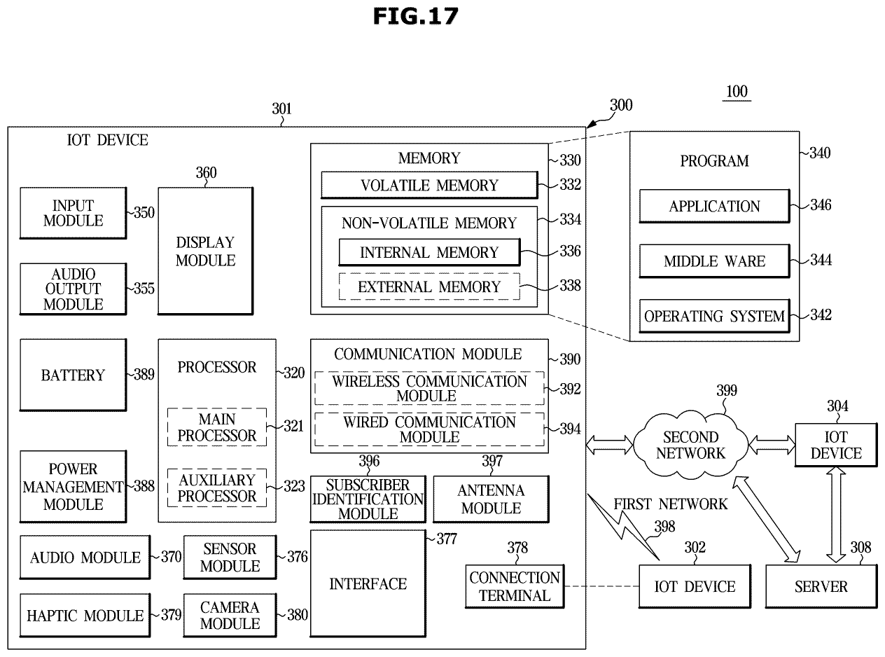

FIG. 17 is a block diagram schematically showing a plurality of refrigerators in an IoT environment according to an embodiment.

IoT devices 301, 302, and 304 of FIG. 17 may correspond to the electronic device 10 or the user device 2 of FIG. 1. In the IoT environment, a plurality of refrigerators 11 may exist. For example, the IoT devices 301, 302, and 304 may respectively be or include the plurality of refrigerators 11.

Referring to FIG. 17, in the IoT environment, an IoT device may communicate with another IoT device 302 through a first network 398 (e.g., a short-range wireless communication network), or communicate with at least one of another IoT device 304 or a server device 308 through a second network (e.g., a long-distance wireless communication network) 399. According to an embodiment, the IoT device may communicate with the other IoT device 304 through the server device 308.

According to an embodiment, the IoT device may include at least one processor 320, at least one memory 330, an input module 350, an audio output module 355, a display module 360, an audio module 370, a sensor module 376, an interface 377, a connection terminal 378, a haptic module 379, a camera module 380, a power management module 388, a battery 389, a communication module 390, a subscriber identification module 396, and/or an antenna module 397. In a case where the IoT device is or include the refrigerator 11, the at least one processor 320 may correspond to the at least one processor 210 of FIG. 9, the at least one memory 330 may correspond to the at least one memory 220 of FIG. 9, the input module 350 may correspond to the at least one input button 171 of FIG. 9, the display module 360 may correspond to the display 172 of FIG. 9, the audio module 370 may correspond to the speaker 173 of FIG. 9, the communication module 390 may correspond to the communication interface 190 of FIG. 9, the sensor module 276 may correspond to the at least one sensor 180 of FIG. 9, and the server device 308 may correspond to the server device 3 of FIG. 1.

At least one (e.g., the connection terminal 378) of the above-mentioned components of the IoT device may be omitted or at least another component may be added to the IoT device. Also, some (e.g., the sensor module 376, the camera module 380, or the antenna module 397) of the components of the IoT device may be integrated into one component (e.g., the display module 360).

The at least one processor 320 may execute software (e.g., program 340) to control at least another component of the IoT device connected to the processor 320 and perform various data processing or operations. In this case, the component of the IoT device connected to the at least one processor 320 may include a hardware or software component.

According to an embodiment, as at least a part of data processing and operations, the at least one processor 320 may store a command or data received from another component (e.g., the sensor module 376 or the communication module 390) in volatile memory 332, process the command or data stored in the volatile memory 332, and store result data in non-volatile memory 334. In this case, the data received from the other component may include information obtained by the sensor module 376.

According to an embodiment, the at least one processor 320 may include a main processor 321 (e.g., a central processing unit or an application processor) or an auxiliary processor 323 (e.g., a graphics processing unit, a neural processing unit (NPU), an image signal processor, a sensor hub processor, or a communication processor) capable of operating independently from or together with the main processor 321. For example, in a case where the IoT device includes the main processor 321 and the auxiliary processor 323, the auxiliary processor 323 may be configured to use less power than the main processor 321 or be specialized for a designated function. The auxiliary processor 323 may be implemented separately from the main processor 321 or as a part thereof.

The auxiliary processor 323 may control at least a part of functions or states associated with at least one component (e.g., the display module 360, the sensor module 376, or the communication module 390) among the components of the IoT device such as, for example, on behalf of the main processor 321 while the main processor 321 is in an inactive (e.g., sleep) state, or together with the main processor 321 while the main processor 321 is in an active (e.g., application execution) state. The auxiliary processor 323 (e.g., an image signal processor or a communication processor) may be implemented as a part of another functionally related component (e.g., the camera module 380 or the communication module 390).

According to an embodiment, the auxiliary processor 323 (e.g., a neural network processing unit) may include a hardware structure specialized for processing artificial intelligence models. The artificial intelligence model may be generated through machine learning. The learning may be performed, for example, on the IoT device itself where the artificial intelligence model is executed, or may be performed through a separate server (e.g., the server device 3). The learning algorithm may include, for example, supervised learning, unsupervised learning, semi-supervised learning, or reinforcement learning. However, embodiments of the present disclosure are not limited to the examples described above. The artificial intelligence model may include a plurality of artificial neural network layers. The artificial neural network may be one from among a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the above-mentioned networks. However, embodiments of the present disclosure are not limited to the examples described above. In addition to or alternatively to the hardware structure, the artificial intelligence model may include a software structure.

The at least one memory 330 may store various data obtained or used by at least one component (e.g., the at least one processor 320 or the sensor module 376) of the IoT device. For example, the data may include input data or output data for software (e.g., the program 340) and commands related thereto. The at least one memory 330 may include the volatile memory 332 or the non-volatile memory 334.

The program 340 may be stored as software in the at least one memory 330 and may include, for example, an operating system 342, middleware 344, or an application 346.

The input module 350 may receive commands or data to be used by a component (e.g., the at least one processor 320) of the IoT device from an outside (e.g., a user) of the IoT device. The input module 350 may include, for example, a microphone, a mouse, a keyboard, a key (e.g., a button), or a digital pen (e.g., a stylus pen).

The audio output module 355 may output an audio signal to the outside of the IoT device. The audio output module 355 may include, for example, a speaker or a receiver. The speaker may be used for general purposes, such as multimedia playback or recording playback. The receiver may be used to receive incoming calls. In an embodiment, the receiver may be implemented separately from the speaker or as part of the speaker.

The display module 360 may visually provide information to the outside (e.g., a user) of the IoT device. The display module 360 may include, for example, a display, a holographic device, or a projector and a control circuit for controlling the corresponding device. In addition, the display module 360 may include a touch sensor configured to detect a touch, or a pressure sensor configured to measure a strength of a force generated by a touch.

The audio module 370 may convert sound into an electrical signal or convert an electrical signal into sound. The audio module 370 may obtain sound through the input module 350, or output sound through the audio output module 355 or an external electronic device (e.g., the electronic device 302) (e.g., a speaker or headphone) directly or wirelessly connected to the IoT device.

The sensor module 376 may detect an operating status (e.g., power or temperature) of the IoT device or an external environmental status (e.g., user status) and generate an electrical signal or data value corresponding to the detected status. According to an embodiment, the sensor module 376 may include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 377 may support one or more designated protocols that may be used to connect the IoT device directly or wirelessly with an external electronic device (e.g., the electronic device 302). In an embodiment, the interface 377 may include, for example, a high definition multimedia interface (HDMI), a universal serial bus (USB) interface, a secure digital (SD) card interface, or an audio interface.

The connection terminal 378 may include a connector through which the IoT device is capable of being physically connected to an external electronic device (e.g., the IoT device 302). According to an embodiment, the connection terminal 378 may include, for example, an HDMI connector, a USB connector, a SD card connector, or an audio connector (e.g., a headphone connector).

The haptic module 379 may convert an electrical signal into a mechanical stimulus (e.g., vibration or movement) or an electrical stimulus that a user is capable of perceiving through tactile or kinesthetic sensations. According to an embodiment, the haptic module 379 may include, for example, a motor, a piezoelectric element, or an electrical stimulation device.

The camera module 380 may capture still images and moving images. According to an embodiment, the camera module 380 may include one or more lenses, image sensors, image signal processors, or flashes.

The power management module 388 may manage power supplied to the IoT device. According to an embodiment, the power management module 388 may be implemented as, for example, at least a part of a power management integrated circuit (PMIC).

The battery 389 may supply power to at least one component of the IoT device. According to an embodiment, the battery 389 may include, for example, a non-rechargeable primary battery, a rechargeable secondary battery, or a fuel cell.

The communication module 390 may establish a direct (e.g., wired) communication channel or wireless communication channel between the IoT device and an external electronic device (e.g., the IoT device 302, the IoT device 304, or the server device 3), and support communication through the established communication channel. The communication module 390 may operate independently from the at least one processor 320 (e.g., application processor) and may include one or more communication processors that support direct (e.g., wired) communication or wireless communication. According to an embodiment, the communication module 390 may include a wireless communication module 392 (e.g., a cellular communication module, a short-range wireless communication module, or a global navigation satellite system (GNSS) communication module) or a wired communication module 394 (e.g., a local area network (LAN) communication module, or a power line communication module). A corresponding communication module of these communication modules may communicate with the external electronic device (e.g., the IoT device 304) through the first network 398 (e.g., a short-range communication network such as Bluetooth, wireless fidelity (WiFi) direct, or infrared data association (IrDA)) or the second network 399 (e.g., a long-range communication network such as a legacy cellular network, a 5G network, a next-generation communication network, the Internet, or a computer network (e.g., a LAN or WAN)). These various types of communication modules may be integrated into a single component (e.g., a single chip) or implemented as a plurality of separate components (e.g., a plurality of chips). The wireless communication module 392 may identify or authenticate the IoT device within a communication network, such as the first network 398 or the second network 399 by using subscriber information (e.g., international mobile subscriber identity (IMSI)) stored in the subscriber identification module 396.

The wireless communication module 392 may support 5G networks and next-generation communication technologies after 4G networks, for example, NR access technology (new radio access technology). The NR access technology may support high-speed transmission (enhanced mobile broadband (eMBB)) of high-capacity data, minimization of terminal power, connection of multiple terminals (massive machine type communications (mMTC)), or ultra-reliable and low-latency communications (URLLC). The wireless communication module 392 may support a high frequency band (e.g., mmWave band), for example, to achieve a high data transmission rate. The wireless communication module 392 may support various technologies for securing performance in a high-frequency band, such as beamforming, massive multiple-input and multiple-output (MIMO), full dimensional MIMO (FD-MIMO), array antenna, analog beam-forming, or large scale antenna. The wireless communication module 392 may support various requirements specified in an IoT device, an external electronic device (e.g., the IoT device 304), or the network system (e.g., the second network 399). According to an embodiment, the wireless communication module 392 may support a peak data rate (e.g., 20 Gbps or more) for eMBB realization, a loss coverage (e.g., 164 dB or less) for mMTC realization, or a U-plane latency (e.g., 0.5 ms or less for each of downlink (DL) and uplink (UL), or 1 ms or less for round trip) for URLLC realization.

The antenna module 397 may transmit or receive a signal or power to or from the outside (e.g., an external electronic device). According to an embodiment, the antenna module 397 may include an antenna including a radiator formed of a conductor or conductive pattern formed on a substrate (e.g., a printed circuit board (PCB)). According to an embodiment, the antenna module 397 may include a plurality of antennas (e.g., an array antenna). In this case, at least one antenna suitable for a communication method used in a communication network, such as the first network 398 or the second network 399, may be selected from the plurality of antennas, for example, by the communication module 390. A signal or power may be transmitted or received between the communication module 390 and an external electronic device via the at least selected antenna. According to some embodiments, another component (e.g., a radio frequency integrated circuit (RFIC)) in addition to the radiator may be additionally formed as a part of the antenna module 397.

According to various embodiments, the antenna module 397 may form a mmWave antenna module. According to an embodiment, the mmWave antenna module may include a printed circuit board, an RFIC positioned on or adjacent to a first side (e.g., a bottom) of the printed circuit board and capable of supporting a designated high frequency band (e.g., a mmWave band), and a plurality of antennas (e.g., an array antenna) positioned on or adjacent to a second side (e.g., a top or side) of the printed circuit board and capable of transmitting or receiving signals in the designated high frequency band.

At least some of the above-mentioned components may be connected to each other and exchange signals (e.g., commands or data) with each other through a communication method (e.g., a bus, general purpose input and output (GPIO), a serial peripheral interface (SPI), or a mobile industry processor interface (MIPI)) between peripheral devices.

According to an embodiment, the commands or data may be transmitted or received between the IoT device and the external device (e.g. the IoT device 302 or the IoT device 304) via the server device 3 connected to the second network 399. Each of the external devices device (e.g. the IoT device 302 or the IoT device 304) may be the same device as the IoT device or a different type of device from the IoT device. According to an embodiment, all or some of operations executed on the IoT device may be executed on one or more of the external devices device (e.g. the IoT device 302, the IoT device 304, and the server 308). For example, in a case where the IoT device needs to perform a function or service automatically or in response to a request from a user or another device, the IoT device may, instead of or in addition to executing the function or service itself, request one or more external devices to perform at least a part of the function or service. The one or more external devices that receive the request may execute the at least a part of the requested function or service, or an additional function or service related to the request, and transmit the result of the execution to the IoT device. The IoT device may process the result as it is or additionally and provide the processed result as at least a part of a response to the request. To this end, cloud computing, distributed computing, mobile edge computing (MEC), or client-server computing technologies may be utilized. The IoT device may provide ultra-low latency services by using, for example, distributed computing or mobile edge computing.

According to another embodiment, a external electronic device may include an IoT device 304. The server device 3 may be an intelligent server that uses machine learning and/or a neural network.

According to an embodiment, the external device (e.g., the IoT device 304) or the server device 308 may be included in the second network 399. The IoT device may be applied to intelligent services (e.g., smart home, smart city, smart car, or healthcare) based on 5G communication technology and IoT-related technology.

The electronic device according to various embodiments of the present disclosure may be various types of devices. The electronic device may include, for example, a portable communication device (e.g., a smartphone), a computer device, a portable multimedia device, a portable medical device, a camera, a wearable device, or a home appliance. The electronic device according to an embodiment of the present disclosure is not limited to the above-mentioned devices.

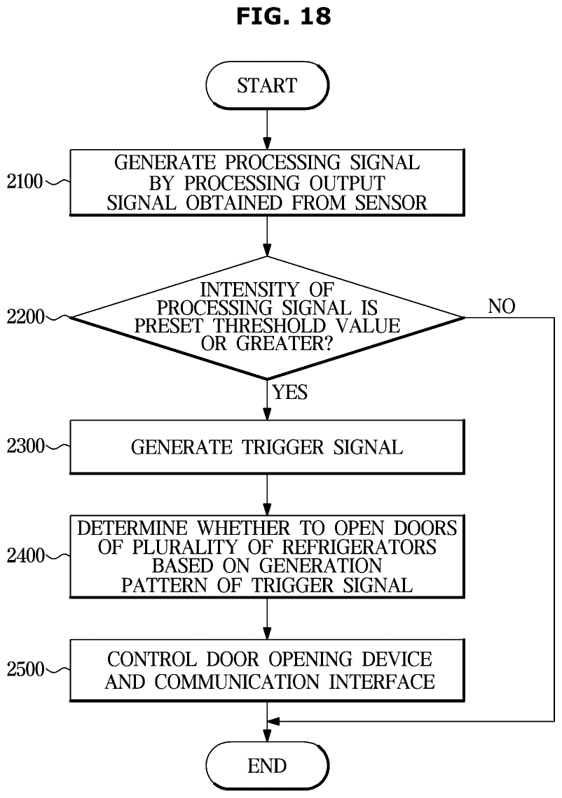

FIG. 18 is a control flowchart of a refrigerator door automatic opening system according to an embodiment.

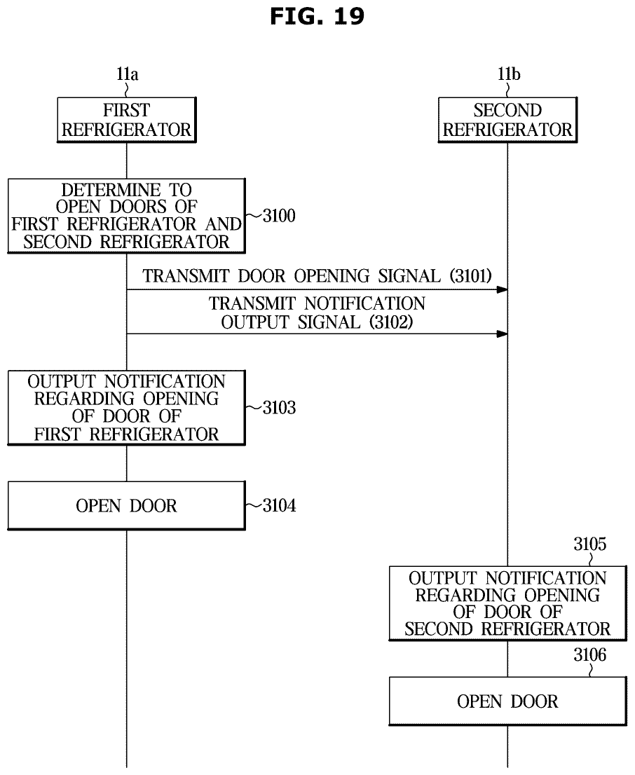

According to an embodiment, the refrigerator door automatic opening system may include a plurality of refrigerators 11. Hereinafter, a case where the refrigerator door automatic opening system includes a first refrigerator 11a, a second refrigerator 11b, and a third refrigerator 11c (see FIGS. 19-22) will be described as an example. However, embodiments of the present disclosure are not limited thereto, and the refrigerator door automatic opening system may include more refrigerators 11, or may be provided in a form in which one of the first refrigerator 11a, the second refrigerator 11b, and the third refrigerator 11c is omitted.

The at least one processor 210 of one refrigerator 11 provided with the sensor 180 among the plurality of refrigerators 11 included in the refrigerator door automatic opening system may process an output signal obtained from the sensor 180 to generate a processing signal (operation 2100). According to various embodiments, the sensor 180 may process an output signal to generate a processing signal and provide the processing signal to the at least one processor 210 of the one refrigerator 11. For example, the at least one processor 210 of the first refrigerator 11a may process an output signal obtained from the sensor 180 provided on the door 150 of the first refrigerator 11a to generate a processing signal.

The at least one processor 210 may identify whether an intensity of the processing signal is equal to or greater than a preset threshold value (operation 2200).

According to the intensity of the processing signal being less than the preset threshold value (NO in operation 2200), no trigger signal may be generated and the doors 150 of the plurality of refrigerators 11 may be maintained in a closed state. For example, the doors 150 of the first refrigerator 11a, the second refrigerator 11b, and the third refrigerator 11c included in the refrigerator door automatic opening system may be maintained in a closed state.

According to the intensity of the processing signal being greater than or equal to the preset threshold value (YES in operation 2200), the at least one processor 210 of the one refrigerator 11 may generate a trigger signal (operation 2300).

The at least one processor 210 of the one refrigerator 11 may determine whether to open doors 150 of a plurality of refrigerators 11, based on a generation pattern of the trigger signal (operation 2400). In this case, the plurality of refrigerators 11 of which the plurality of doors 150 have been determined for opening may include the refrigerator 11 provided with the sensor 180 that has provided the output signal to the at least one processor 210, and at least one other refrigerator 11. In this case, the at least one processor 210 of the one refrigerator 11 may determine whether to simultaneously or sequentially open the doors 150 of the plurality of refrigerators 11 that have been determined for opening.

For example, the at least one processor 210 of the first refrigerator 11a may determine to open the first refrigerator 11a and the second refrigerator 11b based on the generation pattern of the trigger signal. For example, the at least one processor 210 of the first refrigerator 11a may determine to open the first refrigerator 11a, the second refrigerator 11b, and the third refrigerator 11c based on the generation pattern of the trigger signal. In this case, a method, performed by the at least one processor 210 of the one refrigerator 11, of determining whether to open the doors 150 of the plurality of refrigerators 11 based on a generation pattern of a trigger signal may be the same method as the method described above with reference to FIGS. 13 and 14.

The other refrigerator 11 excluding the refrigerator 11 provided with the sensor 180 that has provided the output signal to the at least one processor 210, among the plurality of refrigerators 11 that have been determined for opening, may have been set in advance based on a user input signal. For example, when the at least one processor 210 of the first refrigerator 11a automatically opens the doors 150 of the plurality of refrigerators 11 including the first refrigerator 11a, the at least one processor 210 of the refrigerator 11a may receive a user command for automatically opening at least one of the second refrigerator 11b or the third refrigerator 11c together with the first refrigerator 11a through the input button 171. At this time, when the at least one processor 210 of the first refrigerator 11a automatically opens the doors 150 of the plurality of refrigerators 11 including the first refrigerator 11a, the at least one processor 210 of the refrigerator 11a may receive a user command regarding whether to open the door 150 of at least one from among the second refrigerator 11b and the third refrigerator 11c simultaneously or sequentially with the door 150 of the first refrigerator 11a, through the input button 171.

The at least one processor 210 of the one refrigerator 11 may control the door opening device 160 of each refrigerator 11 to open the door 150 of any one refrigerator 11 that has been determined for opening (operation 2500). Accordingly, the door 150 of the refrigerator 11 that has been determined for opening may rotate. For example, the at least one processor 210 of the first refrigerator 11a may control the door opening device 160 to open the door 150 of the first refrigerator 11a.

In addition, the at least one processor 3210 of the one refrigerator 11 may control the communication interface 190 to transmit a door opening signal to the at least one refrigerator 11 excluding the one refrigerator 11 among the plurality of refrigerators 11 of which the doors 150 have been determined for opening (operation 2500). For example, in a case where the door 150 of the first refrigerator 11a and the door 150 of at least one from among the second refrigerator 11a and the third refrigerator 11c have been determined for opening, the at least one processor 210 of the first refrigerator 11a may control the communication interface 190 to transmit a door opening signal to at least one from among the second refrigerator 11b and the third refrigerator 11c. At this time, the door opening signal transmitted through the communication interface 190 of the one refrigerator 11 may include timing information regarding a time at which the door 150 opens. Accordingly, the plurality of doors 150 that have been determined for opening may be opened simultaneously or sequentially.

The at least one processor 210 of the one refrigerator 11 may control the output interface 190 to output a notification informing opening, before opening the door 150 of the one refrigerator 11. In addition, the at least one processor 210 of the refrigerator 11 may control the communication interface 190 to transmit a notification output signal to the at least one refrigerator 11 excluding the one refrigerator 11 among the plurality of refrigerators 11 that have been determined for opening, in order to output a notification informing opening, before opening the door 150 of the at least one refrigerator 11 excluding the one refrigerator 11 among the plurality of refrigerators 11 that have been determined for opening.

The at least one processor 210 of the one refrigerator 11 may control the communication interface 190 to transmit a notification output signal to the user device 2, in order for the user device 2 to output a notification informing a user of opening, before opening the doors 150 of the plurality of refrigerators 11 that have been determined for opening.

According to various embodiments, a signal transmission and reception process described above may be performed via the server device 3. Hereinafter, transmission and reception of signals and operations of components according to the transmission and reception of signals will be described with reference to FIGS. 19 to 22. In FIGS. 19 to 22, an example of detecting a user or a user input through the sensor 180 included in the first refrigerator 11a among the plurality of refrigerators (e.g., the first refrigerator 11a, the second refrigerator 11b, and the third refrigerator 11c) included in the door automatic opening system and obtaining a trigger signal from an output signal of the sensor 180 to determine whether to open the doors 150 of the plurality of refrigerators 11 will be described. However, embodiments of the present disclosure are not limited thereto, and embodiments of the present disclosure may also be applied in the same way to a case of detecting a user or a user input through the sensor 180 included in another refrigerator 11 among the plurality of refrigerators 11 included in the door automatic opening system and obtaining a trigger signal from an output signal of the sensor 180.

FIG. 19 is an example of a flowchart for automatically opening doors of a plurality of refrigerators in a refrigerator door automatic opening system according to an embodiment.

In the door automatic opening system according to an embodiment, the plurality of refrigerators 11 may transmit and receive control signals and perform a series of operations for door automatic opening through Device-to-Device communication.

According to an embodiment, the first refrigerator 11a may determine to open the first refrigerator 11a and the second refrigerator 11b (operation 3100).

Accordingly, the first refrigerator 11a may transmit a door opening signal to the second refrigerator 11b to open the door 150 of the second refrigerator 11b (operation 3101).

Also, the first refrigerator 11a may transmit a notification output signal to the second refrigerator 11b such that the second refrigerator 11b outputs a notification informing a user of opening of the door 150, before the second refrigerator 11b opens the door 150 of the second refrigerator 11b (operation 3102).

At this time, transmission of the door opening signal and the notification output signal from the first refrigerator 11a to the second refrigerator 11b may be performed simultaneously or sequentially.

Accordingly, the first refrigerator 11a may output a notification regarding opening of the door 150 of the first refrigerator 11a, before opening the door 150 (operation 3103). Thereafter, the first refrigerator 11a may control its door opening device 160 to open the door 150 (operation 3104). According to various embodiments, opening the door 150 of the first refrigerator 11a and outputting a notification regarding opening of the door 150 may be performed simultaneously.

The second refrigerator 11b may output a notification regarding opening of the door 150 of the second refrigerator 11b, before opening the door 150 (operation 3105). Thereafter, the second refrigerator 11b may control its door opening device 160 to open the door 150 (operation 3105). According to various embodiments, opening the door 150 of the second refrigerator 11b and outputting a notification regarding opening of the door 150 may be performed simultaneously.

An example where opening the door 150 of the first refrigerator 11a and outputting a notification regarding opening of the door 150 are performed before opening the door 150 of the second refrigerator 11b and outputting a notification regarding opening of the door 150 is described in the present disclosure. However, embodiments of the present disclosure are not limited thereto, and opening the door 150 of the second refrigerator 11b and outputting a notification regarding opening of the door 150 may be performed before opening the door 150 of the first refrigerator 11a and outputting a notification regarding opening of the door 150.

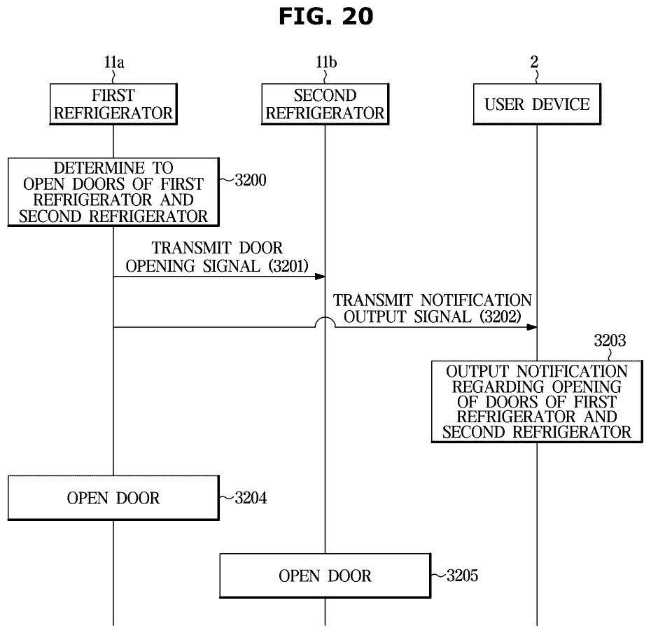

FIG. 20 is an example of a flowchart for automatically opening doors of a plurality of refrigerators in a refrigerator door automatic opening system according to an embodiment.

In the door automatic opening system according to an embodiment, control signals may be transmitted and received and a series of operations for door automatic opening may be performed through Device-to-Device communication between the plurality of refrigerators 11 and the user device 2. Particularly, through communication with the user device 2, a notification regarding door opening may be provided to a user.

According to an embodiment, the first refrigerator 11a may determine to open the first refrigerator 11a and the second refrigerator 11b (operation 3200).

Accordingly, the first refrigerator 11a may transmit a door opening signal to the second refrigerator 11b to open the door 150 of the second refrigerator 11b (operation 3201).

Also, the first refrigerator 11a may transmit a notification output signal to the user device 2 such that the user device 2 outputs a notification informing a user of opening of the doors 50, before opening the doors 150 of the first refrigerator 11a and the second refrigerator 11b (operation 3202).

Accordingly, the user device 2 may output a notification regarding opening of the door 150 of the first refrigerator 11a and the door 150 of the second refrigerator 11b, before the door 150 of each refrigerator 11 is opened (operation 3203).

Thereafter, the first refrigerator 11a may control its door opening device 160 to open the door 150 (operation 3204), and the second refrigerator 11b may control its door opening device 160 to open the door 150 (operation 3205).

According to various embodiments, opening the door 150 of the first refrigerator 11a and opening the door 150 of the second refrigerator 11b may be performed simultaneously or sequentially.

According to various embodiments, opening the door 150 of the first refrigerator 11a and/or the second refrigerator 11b and outputting a notification regarding opening of the door 150 by the user device 2 may be performed simultaneously.

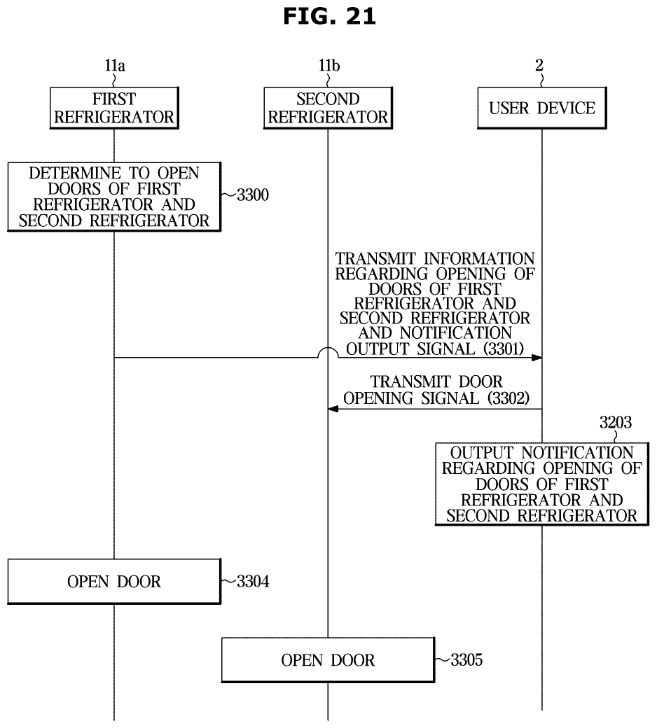

FIG. 21 is an example of a flowchart for automatically opening doors of a plurality of refrigerators in a refrigerator door automatic opening system according to an embodiment.

In the door automatic opening system according to an embodiment, control signals may be transmitted and received and a series of operations for door automatic opening may be performed through Device-to-Device communication between the plurality of refrigerators 11 and the user device 2. Particularly, through communication with the user device 2, a notification regarding door opening may be provided to a user through the user device 2. In addition, the user device 2 may transmit a door opening signal to at least one refrigerator 11 excluding one refrigerator 11 among a plurality of refrigerators 11 that have been determined for opening.

According to an embodiment, the first refrigerator 11a may determine to open the first refrigerator 11a and the second refrigerator 11b (operation 3300).

Also, the first refrigerator 11a may transmit information regarding opening of the door 150 of the first refrigerator 11a and the door 150 of the second refrigerator 11b and a notification output signal to the user device 2 such that the user device 2 outputs a notification informing a user of opening of the doors 150, before opening the doors 150 of the first refrigerator 11a and the second refrigerator 11b (operation 3301).

Accordingly, the user device 2 may transmit a door opening signal to the second refrigerator 11b to open the door 150 of the second refrigerator 11b (operation 3302).

Accordingly, the user device 2 may output a notification regarding opening of the door 150 of the first refrigerator 11a and the door 150 of the second refrigerator 11b, before the doors 150 of the refrigerators 11 are opened (operation 3303).

Thereafter, the first refrigerator 11a may control its door opening device 160 to open the door 150 (operation 3304), and the second refrigerator 11b may control its door opening device 160 to open the door 150 (operation 3305).

According to various embodiments, opening the door 150 of the first refrigerator 11a and opening the door 150 of the second refrigerator 11b may be performed simultaneously or sequentially.

According to various embodiments, opening the door 150 of the first refrigerator 11a and/or the second refrigerator 11b and outputting a notification regarding opening of the door 150 by the user device 2 may be performed simultaneously.

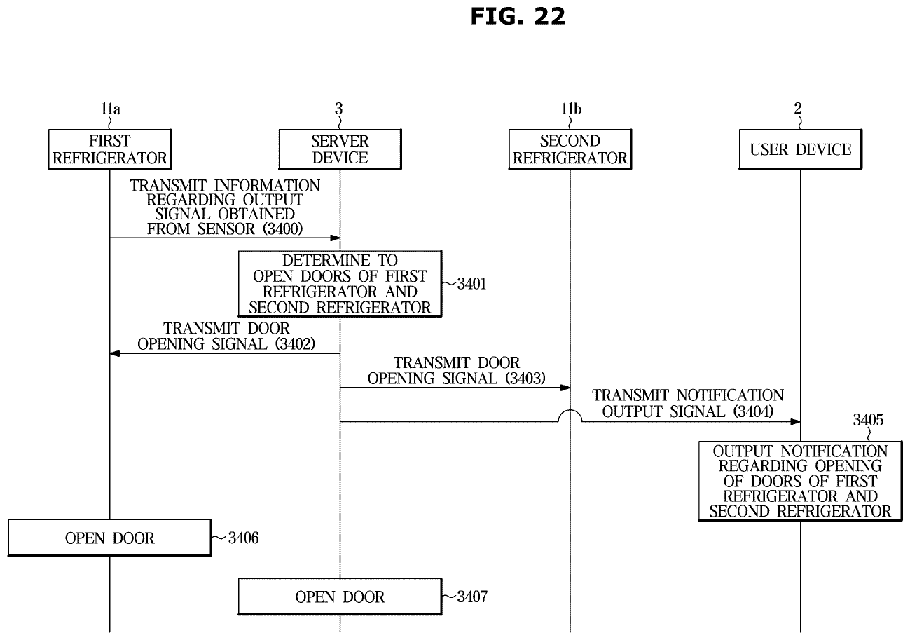

FIG. 22 is an example of a flowchart for automatically opening doors of a plurality of refrigerators in a refrigerator door automatic opening system according to an embodiment.

In the door automatic opening system according to an embodiment, the plurality of refrigerators 11 and the user device 2 may indirectly transmit and receive control signals and perform a series of operations for door automatic opening through Device-to-Server-to-Device Communication via the server device 3.

Through Device-to-Server-to-Device Communication via the server device 3, data may be stored in the server device 3 and analysis and processing based on the data stored in the server device 3 may be possible, thereby enabling complex operations and control.

According to an embodiment, the first refrigerator 11a may transmit information regarding an output signal obtained from the sensor 180 to the server device 3 (operation 3400).

Accordingly, the server device 3 may process the output signal to generate a processing signal, generate a trigger signal based on an intensity of the processing signal being greater than or equal to a preset threshold value, and determine to open the doors 150 of the first refrigerator 11a and the second refrigerator 11b among the plurality of refrigerators 11 based on a generation pattern of the trigger signal for a reference time (operation 3401).

Accordingly, the server device 3 may transmit a door opening signal to the first refrigerator 11a to open the door 150 of the first refrigerator 11a (operation 3402). Also, the server device 3 may transmit a door opening signal to the second refrigerator 11b to open the door 150 of the second refrigerator 11b (operation 3403). At this time, transmission of the door opening signal from the server device 3 to the first refrigerator 11a or the second refrigerator 11b may be performed simultaneously or sequentially.

Also, the server device 3 may transmit a notification output signal to the user device 2 such that the user device 2 outputs a notification informing a user of opening of the doors 150 to the user, before opening the doors 150 of the first refrigerator 11a and the second refrigerator 11b (operation 3404).

Accordingly, the user device 2 may output a notification regarding opening of the door 150 of the first refrigerator 11a and the door 150 of the second refrigerator 11b, before the door 150 of each refrigerator 11 is opened (operation 3405).

Thereafter, the first refrigerator 11a may control its door opening device 160 to open the door 150 (operation 3206), and the second refrigerator 11b may control its door opening device 160 to open the door 150 (operation 3407).

According to various embodiments, opening the door 150 of the first refrigerator 11a and opening the door 150 of the second refrigerator 11b may be performed simultaneously or sequentially.

According to various embodiments, opening the doors 150 of the first refrigerator 11a and/or the second refrigerator 11b and outputting a notification regarding opening of the doors 150 by the user device 2 may be performed simultaneously.

Aspects and effects of embodiments of the present disclosure are not limited to the above-mentioned aspects and effects, and other unmentioned aspects and effects of embodiments of the present disclosure will be clearly understood by one of ordinary skill in the technical art to which the present disclosure belongs from the above description.

Non-limiting example embodiments of the present disclosure have been described with reference to the accompanying drawings. It will be understood by one of ordinary skill in the technical art to which the present disclosure belongs that embodiments of the present disclosure can be embodied in different forms from the example embodiments without departing from the spirit and scope of the present disclosure. Thus, it should be understood that the example embodiments are merely for illustrative purposes and not for limitation purposes.

Meanwhile, embodiments of the present disclosure may be implemented in the form of a recording medium that stores instructions executable by a computer. The instructions may be stored in the form of program codes, and when executed by a processor, the instructions may create a program module to perform operations of the example embodiments. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, a flash memory, an optical data storage device, etc.

Also, the machine-readable storage medium may be provided in the form of a non-transitory storage medium, wherein the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. For example, a “non-transitory storage medium” may include a buffer in which data is temporarily stored.

According to an embodiment of the present disclosure, a method according to various embodiments of the present disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloadable or uploadable) online via an application store (e.g., Play Store™) or between two user devices (e.g., smart phones) directly. When distributed online, at least part of the computer program product (e.g., a downloadable app) may be temporarily generated or at least temporarily stored in the machine-readable storage medium, such as a memory of the manufacturer's server, a server of the application store, or a relay server.

What is claimed is:

1. A refrigerator comprising:
a main body;
a plurality of doors rotatably coupled to the main body;
at least one door opening device configured to independently open the plurality of doors;
a sensor on one door from among the plurality of doors, the sensor configured to detect a user or a user input; and
at least one processor configured to:
generate a processing signal by processing an output signal obtained from the sensor;
generate a trigger signal based on an intensity of the processing signal being greater than or equal to a preset threshold value;
determine to open at least two doors, including the one door, from among the plurality of doors based on a generation pattern of the trigger signal for a reference time; and
control, based on determining to open the at least two doors, the at least one door opening device to open the at least two doors.

2. The refrigerator of claim 1, wherein
the at least one processor is further configured to determine to open the at least two doors, including the one door, based on the trigger signal being continuously generated for the reference time.

3. The refrigerator of claim 1, wherein
the at least one processor is further configured to, based on the trigger signal being intermittently generated for the reference time:
extract at least one trigger signal generation section in which the trigger signal is continuously obtained for a preset threshold time or longer among trigger signal generation sections obtained in the reference time; and
determine to open the at least two doors based on a number of the at least one trigger signal generation section that is extracted being greater than or equal to a preset number.

4. The refrigerator of claim 3, wherein
the at least one processor is further configured to, based on determining to open the at least two doors, determine, based on the number of the at least one extracted trigger signal generation section, at least one door excluding the one door among the plurality of doors determined for opening.

5. The refrigerator of claim 1, wherein
the at least one processor is further configured to control the at least one door opening device to simultaneously or sequentially open the at least two doors that have been determined for opening.

6. The refrigerator of claim 1, wherein
the sensor comprises a touch sensor configured to obtain, as an input signal, a physical characteristic that changes based on a touch of the user.

7. The refrigerator of claim 6, wherein
the touch sensor comprises at least one from among a pressure-sensitive touch sensor, a capacitive touch sensor, a piezoelectric touch sensor, and an optical touch sensor.

8. The refrigerator of claim 1, wherein
the sensor comprises a proximity sensor configured to obtain, as an input signal, a physical characteristic that changes based on an approach by the user to the sensor.

9. The refrigerator of claim 8, wherein
the proximity sensor comprises at least one from among a capacitive proximity sensor, an ultrasonic proximity sensor, and a magnetic proximity sensor.

10. The refrigerator of claim 1, further comprising:
an output interface configured to provide the user with a notification, through sensory information, regarding an opening operation of the refrigerator,
wherein the at least one processor is further configured to control the output interface to output the notification before opening the at least two doors that have been determined for opening.

11. The refrigerator of claim 1, further comprising
a communication interface configured to perform communication with an external device,
wherein the at least one processor is further configured to control the communication interface to transmit a notification output signal to the external device such that the external device outputs a notification informing the user of opening of the at least two doors, before the refrigerator opens the at least two doors that have been determined for opening.

12. A refrigerator door automatic opening system comprising:
a plurality of refrigerators comprising:
a first refrigerator comprising:
a first door;
a first door opening device configured to open the first door;
a first communication interface;
at least one first processor connected to the first door opening device and the first communication interface; and
a sensor on the first door, the sensor configured to detect a user or a user input; and
a second refrigerator comprising:
a second door;
a second door opening device configured to open the second door;
a second communication interface; and
at least one second processor connected to the second door opening device and the second communication interface,
wherein the at least one first processor of the first refrigerator is configured to:
generate a processing signal by processing an output signal obtained from the sensor;
generate a trigger signal based on an intensity of the processing signal being greater than or equal to a preset threshold value;
determine, based on a generation pattern of the trigger signal for a reference time, to open the first door of the first refrigerator and the second door of the second refrigerator;
control, based on determining to open the first door, the first door opening device to open the first door of the first refrigerator; and
control, based on determining to open the second door, the first communication interface to transmit a door opening signal to the second refrigerator to open the second door.

13. The refrigerator door automatic opening system of claim 12, wherein
the at least one first processor of the first refrigerator is further configured to, based on the trigger signal being continuously generated for the reference time, determine to open the first door of the first refrigerator and the second door of the second refrigerator.

14. The refrigerator door automatic opening system of claim 12, wherein
the at least one first processor of the first refrigerator is further configured to, based on the trigger signal being intermittently generated for the reference time:
extract at least one trigger signal generation section in which the trigger signal is continuously generated for a preset threshold time or longer among trigger signal generation sections generated in the reference time; and
determine to open the first door of the first refrigerator and the second door of the second refrigerator based on a number of the at least one trigger signal generation section that is extracted being greater than or equal to a preset number.

15. The refrigerator door automatic opening system of claim 14, wherein
the at least one first processor of the first refrigerator is further configured to, based on the number of the at least one trigger signal generation section that is extracted being less than the preset number, determine to open only the first door from among the first door and the second door.

16. A control method of a refrigerator performed by the refrigerator, the control method comprising:
generating a processing signal by processing an output signal obtained from a sensor of the refrigerator, the sensor provided on one door from among a plurality of doors of the refrigerator;
generate a trigger signal based on an intensity of the processing signal being greater than or equal to a preset threshold value;
determining to open at least two doors, including the one door, from among the plurality of doors based on a generation pattern of the trigger signal for a reference time;
controlling, based on determining to open the at least two doors, at least one door opening device of the refrigerator to open the at least two doors,
wherein the at least one door opening device is configured to independently open the plurality of doors.

17. The control method of claim 16, wherein the determining comprises determining to open the plurality of doors, including the one door from among the plurality of doors, based on the trigger signal being continuously generated for the reference time.

18. The control method of claim 16, wherein the determining comprises:
extracting, based on the trigger signal being intermittently generated from the reference time, at least one trigger signal generation section in which the trigger signal is continuously obtained for a preset threshold time or longer among trigger signal generation sections obtained in the reference time; and
determining to open the at least two doors based on a number of the at least one trigger signal generation section that is extracted being greater than or equal to a preset number.

19. The control method of claim 18, wherein the determining further comprises:
extracting, based on the trigger signal being intermittently generated from the reference time, at least one trigger signal generation section in which the trigger signal is continuously obtained for a preset threshold time or longer among trigger signal generation sections obtained in the reference time; and
determining to open only the one door, from among the at least two doors, based on a number of the at least one trigger signal generation section that is extracted being less than or equal to a preset number.

20. The control method of claim 16, wherein the controlling comprises controlling the at least one door opening device to simultaneously or sequentially open the at least two doors that have been determined for opening.
